(19) United States
(12) Patent Application Publication
(10) Pub. No.: US 2007/0195399 A1
(43) Pub. Date: Aug. 23, 2007

(54) Stacked-cell display with field isolation layer

(75) Inventors: Peter T. Aylward, Hilton, NY (US); Kelly S. Robinson, Fairport, NY (US); Kam C. Ng, Rochester, NY (US); John C. Brewer, Rochester, NY (US)

Correspondence Address: Patent Legal Staff;Eastman Kodak Company, 343 State Street, Rochester, NY, 14650-2201, US

(73) Assignee: Eastman Kodak Company

(21) Appl. No.: 11/360,932

(22) Filed: Feb. 23, 2006

(51) Int. Cl. G02B 26/00

(52) U.S. Cl. 359/296

(57) ABSTRACT

The present invention relates generally to the field of electro-optical modulating displays, for example, electrophoretic displays, and more particularly to a display having an array of stacked cells. In particular, the invention discloses the use of a electrical field isolation layer between the stacked arrays of microcells, , or alternative means, for reducing or eliminating cross-talk between the microcells in vertically adjacent layers of the stacked display.

### CROSS-REFERENCE TO RELATED APPLICATIONS

The present application is related to U.S. application Ser. No. 10/953,623, filed Sep. 29, 2004, by Peter T. Aylward et al. and entitled, “Antistatic Layer for Electrically Modulated Display,” hereby incorporated by reference.

### FIELD OF THE INVENTION

The present invention relates generally to the field of electro-optical modulating displays, for example, electrophoretic displays, and more particularly to a display having an array of stacked cells.

### BACKGROUND OF THE INVENTION

The electrophoretic display is a type of electro-optic display that offers an electronic alternative to conventional printed paper media for many applications. Based on the electrophoresis phenomenon of charged pigment particles suspended in a solvent, the electrophoretic display is non-emissive, unlike conventional electronically modulated surfaces such as cathode ray displays or Organic Light Emitting Diode (OLED) displays. Unlike other types of sheet materials containing magnetic memory areas that can be written electronically, the electrophoretic display advantageously provides a visible record for the viewer. Electrophoretic media systems exist that maintain electronically changeable data without power. Such systems can be electrophoretic, such as devices available from E-ink Corporation, Cambridge, Mass., or Gyricon systems from Xerox Corporation, Stamford, Conn., or devices using polymer dispersed cholesteric materials.

As first proposed in the 1960's, the electrophoretic display typically comprises a display cell having two electrode plates placed opposite each other, separated by spacers. One of the electrodes is usually transparent. A suspension composed of a colorant is enclosed between the two electrode plates. This suspension can be a clear or colored solvent having charged, suspended pigment particles. When a voltage difference is imposed between the two electrodes, the resulting electric field that is formed causes the pigment particles to respond in a pattern such that either the color of the pigment or the color of the solvent is predominant, according to the polarity of the voltage difference.

Since the inception of this technology, there has been considerable research directed to its implementation and optimization. One favorable development relates to the architecture of the individual electrophoretic cells themselves. Whereas early designs used electrodes disposed opposite each other, typically at the top and bottom on vertically opposite sides of the electrophoretic cell, more recent work has introduced an electrophoretic cell having its control electrodes disposed non-vertically, not on opposite sides parallel to the face of the display. For such in-plane electrode devices, collector electrodes are provided adjacent to and significantly in the same plane such that particles typically move significantly parallel rather than perpendicular to the face of the display (See, for example, Kishi, E. et al., “Development of In-plane EPD,” SID 2000, pp. 24-27, and Liang et al., U.S. Publication No. 2003/0035198). In-plane devices have also been called “horizontal migration type electrophoretic display devices,” (See U.S. Pat. No. 6,741,385).

In this so-called “in-plane” cell design, the control electrodes can lie along one side of the electrophoretic cell, such as at the top or bottom of the cell, as compared to the top and bottom of the display, the top of the display referring to the front viewing side of the display. This arrangement is clearly advantaged for manufacturability, since all of the electrodes can be fabricated as part of the same layer. The “in-plane” designation may have both electrodes for each electrophoretic cell formed on the same side of a sheet of a support substrate, for example, or formed on opposite sides of a substrate sheet, or otherwise electrically isolated from each other in some suitable manner, but lying generally within a limited portion of the vertical height of the electrophoretic device. An example of an in-plane electrophoretic design is described in U.S. Pat. No. 6,885,495 entitled “Electrophoretic Display with In-plane Switching” to Liang et al. U.S. Publication No. 2003/0034950 entitled “Electrophoretic Display with Dual Mode Switching” by Liang et al. describes a hybrid electrophoretic device architecture having both opposed electrode and in-plane switching modes. Similarly, U.S. Pat. No. 6,751,007 entitled “Transflective Electrophoretic Display” to Liang et al. also describes an electrophoretic device architecture usable in either opposed electrode or in-plane switching modes.

The electrophoretic cell operates by changing to one of at least two optical states, forming an electrical field that extends between electrodes in at least one of its optical states. In types of electrophoretic cells that use facing electrode plates, the electrical field is conventionally represented as shown in FIG. 1A. An electrophoretic cell 10 has opposed or facing electrodes 12 and 14. When there is a charge difference between electrodes 12 and 14, the electrical field is represented by field lines 16, simply extending between electrodes 12 and 14. Here, field lines 16 are generally parallel to light path L, whether electrophoretic cell 10 is of the reflective or transmissive type.

The alternate in-plane arrangement, shown in FIG. 1B, is slightly more complex. Here, field lines 16, initially extending normal to the surfaces from which they originate, curve across light path L, between in-plane electrodes 22 and 24, forming an electrical field that is generally transverse to light path L. This distinction between electrical field vectors formed between facing electrodes 12, 14 in FIG. 1A and in-plane electrodes 22, 24 in FIG. 1B can be of relatively little importance for single-cell electrophoretic device behavior. However, as is well known in the signal processing art, an electrical field of some level that is generated at one component can have some impact on neighboring components, causing the undesirable phenomenon known as “crosstalk.” As devices are further miniaturized and electrodes are spaced more tightly as a result, this problem can become more acute.

Crosstalk from electrical fields in an electro-optic device array is generally a concern for its effect in a direction perpendicular to field lines 16. Referring back to FIG. 1A, a neighboring electrophoretic cell that is adjacent to electrophoretic cell 10 may be affected by crosstalk from the electrical field between top and bottom electrodes 12 and 14. In recognition of this problem, U.S. Publication No. 2004/0036951 entitled “Electrophoretic Display Device” by Johnson et al. describes using an electrical shielding element or highly dielectric barrier between neighboring electrophoretic cells of this top-bottom electrode type, where the neighboring electrophoretic cells lie in the same plane.

By comparison, the in-plane architecture described with reference to FIG. 1B is not susceptible to such a crosstalk problem from its neighbors in the same plane. The electric field between electrodes 22 and 24 is orthogonal to the electric field of electrophoretic cells 10 using the FIG. 1A architecture. Similarly, an arrangement using facing electrodes placed along the sides of the electrophoretic cell, so that the electric field is orthogonal to light path L, would exhibit little or no crosstalk effects between adjacent cells.

Stacked cell configurations have been proposed for providing color displays using electrophoretic devices. For example, U.S. Pat. No. 6,727,873 entitled “Reflective Electrophoretic Display with Stacked Color Cells” to Gordon II et al. and U.S. Pat. No. 6,844,957 entitled “Three Level Stacked Reflective Display” to Matsumoto et al. describe a color display using three vertically stacked electrophoretic cells. Each cell would have electrophoretic materials for providing a complementary color component, such as cyan, magenta, or yellow, for example. Similarly, U.S. Pat. No. 6,680,726 entitled “Transmissive Electrophoretic Display with Stacked Color Cells” also to Gordon II et al. describes a transmissive stacked cell configuration, in which each cell would have electrophoretic materials for providing a primary color component, such as red, green, or blue, for example. In any of these embodiments, color would be produced using an appropriate combination of color components from three stacked cells. U.S. Publication No. 2003/0231162 entitled “Color Electrophoretic Display Device” by Kishi discloses a color electrophoretic display using two stacked cells, where one of the cells can produce two colors.

The electrophoretic cell architecture described in both the '873 and '726 Gordon II et al. patents employs a central post electrode and collecting electrodes that lie on sides of the cell wall. Some electrical shielding is provided for the post electrodes themselves in order to minimize undesirable signal coupling between cells in the stack. However, it can be observed that the electrode arrangement that is described in the '873 and '726 Gordon II et al. patents sets up an electric field orthogonal to the light path within each stacked cell. Thus, it is likely that there can be some crosstalk interaction between neighboring cells in the stack of electrophoretic cells when using this type of stacked cell configuration. Unlike the crosstalk condition described with reference to the Johnson et al. application (U.S. Publication No. 2004/0036951), where there is crosstalk between neighboring cells that lie in the same plane, this type of crosstalk is between vertically stacked electrophoretic cells. A stacked cell using the in-plane design shown in FIG. 1B would have a similar crosstalk problem. Crosstalk problems would also be likely for staggered stacked cell arrangements, such as those described in U.S. Pat. No. 6,788,452 entitled “Process for Manufacture of Improved Color Displays” and U.S. Publication No. 2004/0169912 entitled “Electrophoretic Display and Novel Process for its Manufacture,” both by Liang et al.

Although cell-to-cell crosstalk for electrophoretic cells lying in the same plane has been recognized as a problem, crosstalk between electrophoretic cells arranged in a stack has not been addressed. Some of the device architectures, such as those described in the '873 and '726 Gordon II et al. patents, either inherently provide shielding or have an opposed top-bottom electrode arrangement in the electrophoretic cell that forms a field generally in parallel to light path L and not, therefore, causing crosstalk with other cells above or below in the stack. However, none of these patent disclosures call attention to the crosstalk problem, nor do they suggest any method for compensating for this problem with an in-plane electrode arrangement.

Referring to FIGS. 1D and 1E, crosstalk effects are shown for a simple stack 20 consisting of two electrophoretic cells 10a and 10b containing particles 18 in a carrier fluid. In FIG. 1D, upper cell 10a is switched to one of its optical states in which an electrical field is formed between its in-line electrodes 22 and 24. As electrical field lines 16 show, the electrical field, intended to affect only upper electrophoretic cell 10a, actually affects both upper and lower electrophoretic cells 10a and 10b. It can be appreciated from FIG. 1D that this type of unintended affect, even where it is slight, can cause some loss of image quality for a display using these devices. Similarly, the crosstalk effects shown in FIG. 1E, although not as pronounced, could also have an unintended impact on the performance of neighboring electrophoretic cells 10 in the stack.

The crosstalk problem for stacked electrophoretic cells is further complicated by light path considerations. As one consideration, any type of field isolation solution used for stacked cell crosstalk should not obstruct the light path and should have minimal or no impact on brightness or on the image aperture ratio. As another consideration, parallax problems, chromatic aberration, and other undesirable optical effects must be minimized, requiring that stacked electrophoretic cells be very closely spaced, with only a minimum of distance between them. This requirement exacerbates the problem of field isolation. Thus, in order for stacked electrophoretic arrays to prove commercially successful, there is a need for solutions to the field crosstalk problem, where these solutions both minimize crosstalk effects and optimize image quality.

### PROBLEM TO BE SOLVED BY THE INVENTION

There is a need for techniques and apparatus for minimizing electrical field crosstalk between vertically adjacent electrophoretic cells in an array of stacked electrophoretic cells.

### SUMMARY OF THE INVENTION

The present invention is directed to overcoming one or more of the problems set forth above

This invention relates to a stacked electro-optical modulating display comprising at least two stacked state-changing layers, the stacked display comprising an array of pixels for displaying an image, each pixel associated with one or more microcells in each of the stacked state-changing layers:

(a) a first state-changing layer comprising a first array of microcells, each microcell in the first array containing a first imaging material that responds to a first electrical field to switch the microcell between at least two optical states, a first and second optical state;

(b) first in-plane electrodes, for each microcell in the first array in the first state-changing layer, that provide the first electrical field associated with changing the optical state in each microcell in the first array;

(c) a second state-changing layer adjacent the first state-changing layer, the second state-changing layer comprising a second array of microcells in which the microcells in the second array are spatially registered in pixel formation with the microcells in the first array, each microcell in the second array containing a second imaging material that responds to a second electrical field to switch the microcell between the first and second optical states;

(d) second in-plane electrodes, for each microcell in the second array in the second state-changing layer, that provide the second electrical field associated with changing the optical state of the microcell in the second array; and

(e) between the first state-changing layer and the second state-changing layer, a first electrical field isolation layer between the first array of microcells and the second array of microcells, for reducing or eliminating crosstalk between the spatially registered microcells in vertically adjacent state-changing layers in the stacked display.

A second aspect of the present invention relates to a stacked electro-optical modulating display comprising at least two stacked state-changing layers, the stacked display comprising an array of pixels for displaying an image, each pixel associated with one or more microcells in each of the stacked state changing layers:

(a) a first state-changing layer comprising a first array of microcells, each microcell in the first array containing a first imaging material that responds to a first electrical field to switch the microcell between at least two optical states, a first and second optical state, the first imaging material comprising charged colored colloidal particles and charged substantially invisible colloidal particles, relatively smaller than the charged colored colloidal particles, both particles dispersed in a carrier fluid, which particles respond to the first electrical field, but which charged substantially invisible colloidal particles effectively constrain field strength to within the microcell; and

(b) a second state-changing layer comprising a second array of microcells, each microcell in the second array containing a second imaging material that responds to a second electrical field to switch the microcell between at least two optical states, a first and second optical state, the second imaging material comprising charged colored colloidal first particles, of a different color than the particles in the first imaging material, and charged substantially invisible colloidal particles, relatively smaller than the charged colored colloidal particles, both particles dispersed in a carrier fluid, which particles respond to the first electrical field, but which charged substantially invisible particles effectively constrain field strength to within the microcell.

Yet a third aspect of the invention relates to a stacked electro-optical modulating display comprising at least two stacked state-changing layers, the stacked display comprising an array of pixels for displaying an image, each pixel associated with one or more microcells in each of the stacked state-changing layers:

(a) a first state-changing layer comprising a first array of microcells, each microcell in the first array containing a first imaging material that responds to a first electrical field to switch the microcell between at least two optical states, a first and second optical state;

(b) first in-plane electrodes, for each microcell in the first array in the first state-changing layer, that provide said first electrical field associated with changing the optical state in each microcell in the first array;

(c) a second state-changing layer adjacent the first state-changing layer, the second state-changing layer comprising a second array of microcells in which the microcells in the second array are spatially registered in pixel formation with the microcells in the first array, each microcell in the second array containing a second imaging material that responds to a second electrical field to switch the microcell between the first and second optical state; and

(d) second in plane electrodes, for each microcell in the second array in the second state-changing layer, that provide said second electrical field associated with changing the optical state of the microcell in the second array;

wherein the first and second imaging materials substantially lie between the first and second in-plane electrodes, thereby substantially maximizing the distance between the first and second electrodes.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1A is a cross-sectional side view showing electric field lines in a prior art electrophoretic cell with opposing electrodes;

FIG. 1B is a cross-sectional side view showing electric field lines in a prior art electrophoretic cell with in-plane electrodes;

FIG. 1C is a cross-sectional side view showing features of an electrophoretic cell in another embodiment;

FIG. 1D is a cross-sectional side view showing crosstalk effects for a stacked cell;

FIG. 1E is a cross-sectional side view showing additional crosstalk effects for a stacked cell;

FIG. 2 is a cross-sectional side view showing a stacked arrangement of electrophoretic cells;

FIG. 3 is a perspective view showing a stacked display having two state changing layers of electrophoretic cells;

FIG. 4 is a cross-sectional side view showing a preferred embodiment of the present invention, using an electrical field isolation layer between electrophoretic cells;

FIG. 5 is a cross-sectional side view showing an electrical field isolation layer in one embodiment;

FIG. 6 is a cross-sectional side view showing an alternate arrangement of electrophoretic cells in a stack;

FIG. 7 is a cross-sectional side view showing another alternate arrangement of electrophoretic cells in a stack;

FIG. 8 is a cross-sectional side view showing an embodiment having three stacked electrophoretic cells;

FIGS. 9A and 9B are cross-sectional views showing an embodiment using charged colloidal particles;

FIG. 10 is a schematic diagram showing parameters for determining surface resistivity for a low-resistivity layer in one embodiment;

FIGS. 11A and 11B are cross-sectional views showing an embodiment using a hole transport layer;

FIGS. 12A and 12B are cross-sectional views showing an embodiment using charged colloidal particles suspended within the electrophoretic cell itself; and

FIG. 13 is another preferred embodiment of the present invention, using an electrical field isolation layer between electrophoretic cells, in which opposing in-plane electrodes are on the sidewalls of the microcells.

### DETAILED DESCRIPTION OF THE INVENTION

As indicated above, the present invention is directed to providing a stacked electro-optical cell having minimum electrical field crosstalk. The apparatus of the present invention compensates for crosstalk by using an electrical field isolation layer between two electro-optic cells in the stack.

The term electro-optic as it is applied to a material or to a display has its conventional meaning in the imaging arts, referring to modulation of a material having at least first and second display states that differ in at least one optical property. A state-changing mechanism causes an electro-optical material, such as an electro-optical imaging fluid, to change between its first and second display states according to application of an electrical field or electron transfer to the imaging material. Typically, the optical property is color perceptible to the human eye; however, some other optical property can also be affected, such as optical transmission, reflectance, luminescence, or a modulation of wavelengths outside the visible range.

The electro-optical imaging fluid described with reference to the present invention may be electro-optically modulated and can be reflective or transmissive. Light modulating fluid materials are electrophoretic in the described embodiments, but could also be electrochemical or electrochromic, electrowetting fluids, or may use particles such as Gyricon particles or liquid crystals.

The imaging device of the present invention has various layers of imaging and support materials, with each layer substantially orthogonal to the light path. As used herein, the terms “over,” “above,” “on,” “under,” and the like, with respect to layers in the display element, refer to the order of the layers generally, but do not necessarily indicate that the layers are immediately adjacent or that there are no intermediate layers. The term “front,” “upper,” and the like refer to the side of the display element closer to the side being viewed during use.

The term “vertical,” as in “vertical stack” relates to the relative arrangement of neighboring electrophoretic cells in the stack, where each electrophoretic cell provides modulation for a portion of the light traveling through the stack. That is, for the description given herein, “vertical” can be considered as generally in parallel to the light path.

For the description of the present invention that follows, drawings are provided to illustrate key concepts, processes, and relationships. It must be noted that structures in these drawings are not drawn with attention to scale, but rather to show key structural components and functional relationships more clearly.

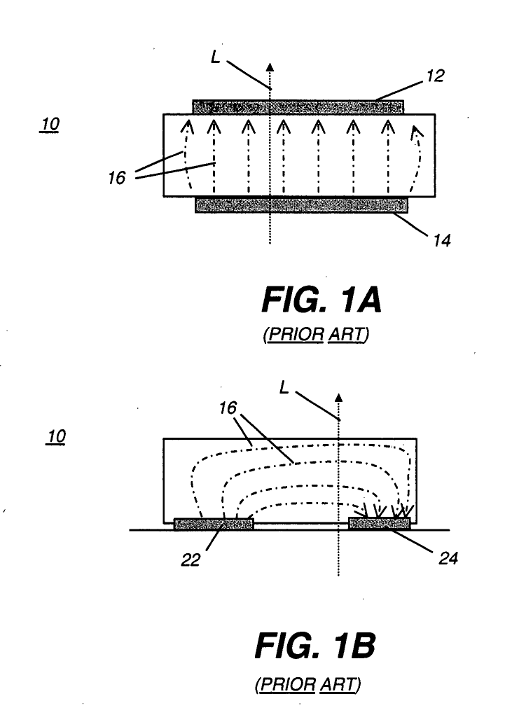

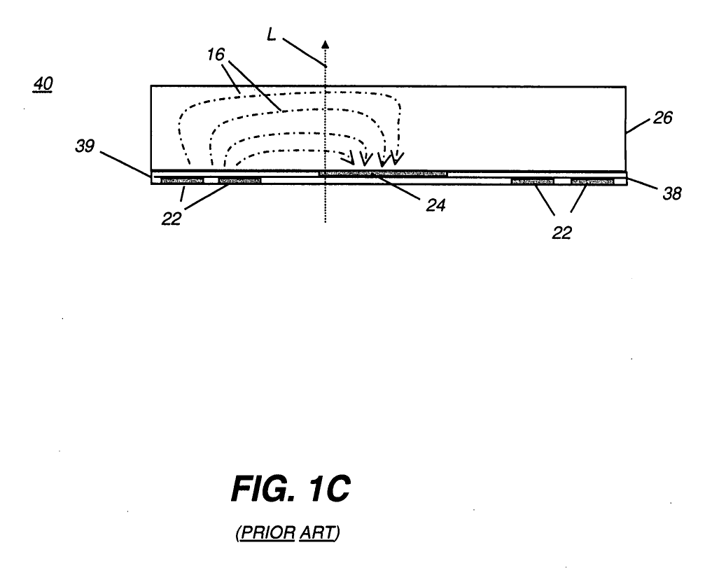

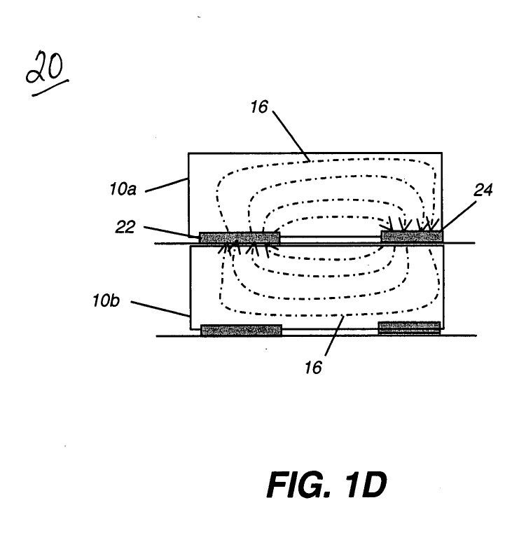

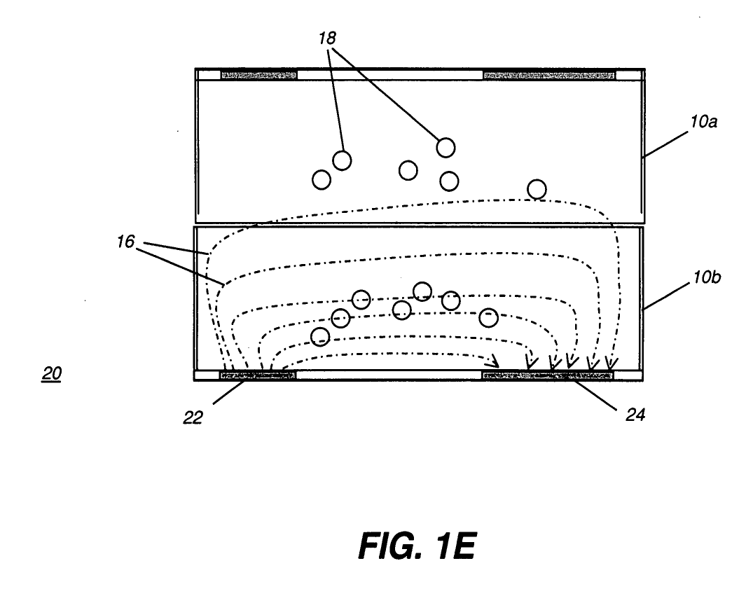

Referring to FIG. 1C, there is shown an embodiment of an electro-optic cell 40 such as an electrophoretic cell with features related to the present invention. A microcell 26 contains imaging material that responds to the electrical field generated between electrodes 22 and 24. An electrode layer 38 contains electrodes 22 and 24 in an “in-plane” arrangement. The electrodes 22 and 24 themselves may not actually be formed exactly on the same plane, as the term “plane” is most strictly defined, but may be formed on opposite sides of a substrate 39 as shown in FIG. 1C. Electrodes 22 and 24 and any substrate 39 should be transparent to visible light, with a transmittivity of at least 75%. This in-plane arrangement, with electrodes 22 and 24 formed onto a layered structure, is advantaged for manufacturability, but is not the only arrangement for forming an electrical field of some level that is transverse to light path L. Electrodes 22, 24 could alternately be distributed along opposite sidewall surfaces of microcell 26 for some embodiments of the present invention. It should also be noted that there may be a number of ways to distribute electrodes 22, 24 relative to one surface of microcell 26. The in-plane terminology is best understood by considering the generally planar nature of the display surface, in which an array of electrophoretic cells is arranged along a plane, typically in rows and columns, in order to represent pixels in the two-dimensional image that is formed thereon. In the in-plane electrophoretic cell architecture, electrodes that form the electrical field within a cell are spaced apart from each other in a direction that is parallel to the plane of the display surface, when the display is lying flat. This in-plane arrangement of electrodes is used to form an electric field that lies substantially parallel to the plane of the display surface. In general, the electrodes for providing an image-forming electric field are positioned on one side of the microcell that is parallel to the face of the display and/or on the sides of the microcells perpendicular to the face of the display. Thus, this excludes electrodes being on opposite sides of the microcell, which sides are parallel to the face of the display, also referred to as a parallel or an out-of-plane arrangement of opposing electrodes. In an out-of-plane configuration, there is no separation distance between electrodes in a direction parallel to the plane of the display surface; instead, there is only a separation distance in a direction normal or perpendicular to the plane of the display surface. The in-plane arrangement of electrodes results in the field lines being horizontal to a significant extent and the movement of the particles in the microcell, under the influence of the electrical field produced by the electrodes, being significantly horizontal (that is, parallel to the face of the display or perpendicular to the light perpendicularly hitting the face of the display). The present arrangement of electrodes is generally synonymous with the term in-plane most broadly construed. In the preferred embodiment, a line perpendicular to the face of the display does not intersect opposing electrodes in a microcell that provide an image-forming electric field. Preferably, the in-plane electrodes are located either on one side of the electro-optical fluid in the microcells or in relative proximity to the that side relative to the opposite side, wherein said sides refer to the sides of the microcell parallel to the face of the display.

For simplicity in the figures that follow, only two electrodes 22, 24 are shown; however, it should be observed that multiple patterned electrode arrangements are possible and should be considered to be within the scope of the present invention. This includes hybrid arrangements such as those that allow both in-line and opposing electrodes, as are disclosed in the Liang et al. application (U.S. Publication No. 2003/0034950) cited above. Where imaging material in microcell 26 has particulate components, these components predominantly move along the direction of field lines 16, transverse to light path L.

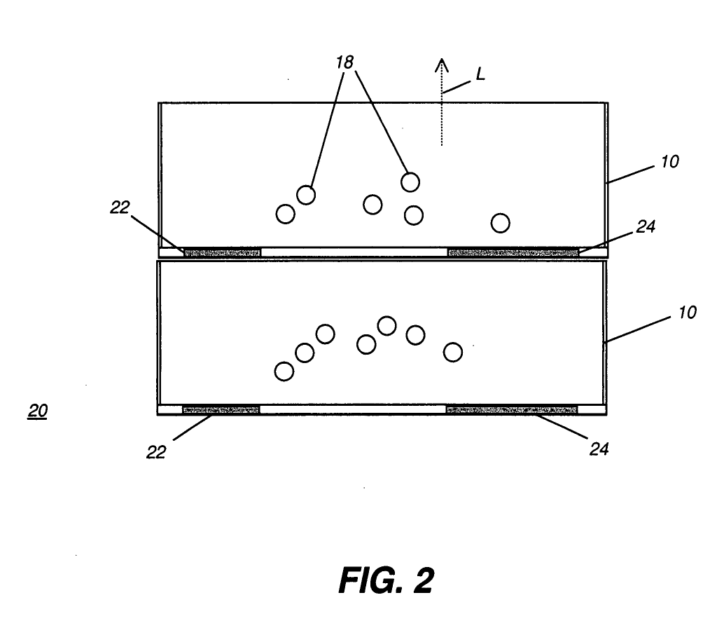

Referring to FIG. 2, there is shown, in side view, a stack of electrophoretic cells 20 containing particles 18 in a carrier fluid and having two electrophoretic cells 10 of the in-plane type, aligned along light path L. The stack of electrophoretic cells 20 typically forms a pixel. In plan view, considered relative to the plane extending from the page, each electrophoretic cell 10 is typically square or round in shape but may also be rectangular, hexagonal, or of some other suitable shape for forming an image. In one embodiment, electrophoretic cell 10 has a rectangular shape with side dimensional ratio in the range from 1:1 to 1:5

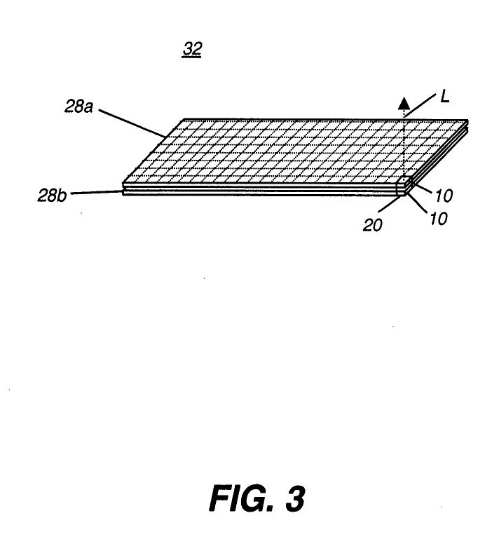

As is represented in FIG. 3, a display device 32 has multiple planar state-changing layers 28a, 28b of electrophoretic cells 10. Each of the individual electrophoretic cells 10 is, in turn, part of a layer 28a, 28b of electrophoretic cells 10. Multiple pixels are thus formed as multiple aligned stacks of electrophoretic cells 20. It is noteworthy that alignment means that the stacked electrophoretic cells 10 in each respective state-changing layer 28a, 28b are spatially registered with respect to each other, such that each cell in a pixel is either directly on top of each other or staggered by some distance. While two state-changing layers 28a and 28b are shown, more than two layers can be provided, as shown in subsequent embodiments.

In other words, the electro-optical modulating display device comprises an array of pixels, each pixel associated with at least one cell of electro-optical imaging fluid in a state changing layer and multiple cells in a stacked-cell arrangement. A pixel is defined herein as spatially related and adjacent, independently controllable cells that contribute to the overall display structure. In such a pixel, the cells that make up the pixel are stacked upon each other in the direction of viewing. A cell is defined herein as the smallest structural unit of the electro-optical modulating display in which the movement of particles, which can result in the formation of color (or absence of a color) in the cell, is independently controlled relative to other elements of the display, wherein the cells are used in an array to form an image, which can be a digital image in which each pixel has two or more optical states, optionally including the control of density by partial migration of particles, enabled by the predictable mobility of the particles in the carrier fluid, wherein at least one optical state is colored by the particles. Individual cells most commonly comprise a reservoir of imaging fluid and at least one pair of electrodes.

In operation, each electrophoretic cell 10 has, as its imaging material, charged colored particles 18 suspended in a dielectric liquid medium. When a voltage difference is imposed between electrodes 22 and 24, particles 18 arrange themselves according to the electric field that forms, such that either the color of the particles or the color of the liquid medium is predominant, according to the polarity of the voltage difference. As an indicator of approximate scale in typical embodiments, cell dimensions generally range from about 10 to about 15 microns in thickness, with typical pixel widths in the 100 to 1000 micron range and possibly smaller.

As described earlier in the background section, FIG. 1D shows one predominant type of crosstalk condition for electrodes 22, 24 for adjacent electrophoretic cell 10b. FIG. 1E showed another less pronounced type of undesirable crosstalk condition in which an electrical field that is formed in one electrophoretic cell 10b extends into an adjacent stacked electrophoretic cell 10a. This crosstalk can have an undesirable effect on the position of charged particles 18 in upper electrophoretic cell 10a, adversely affecting color density or other characteristics.

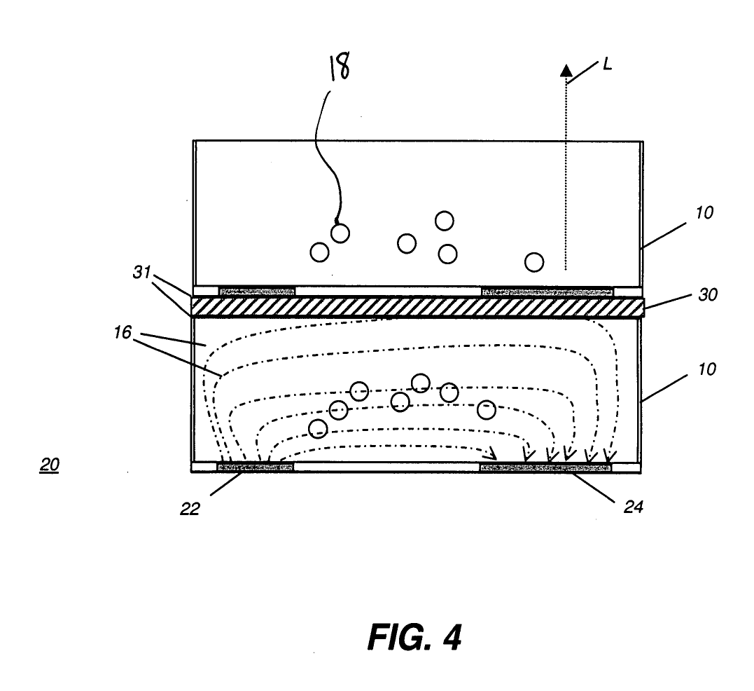

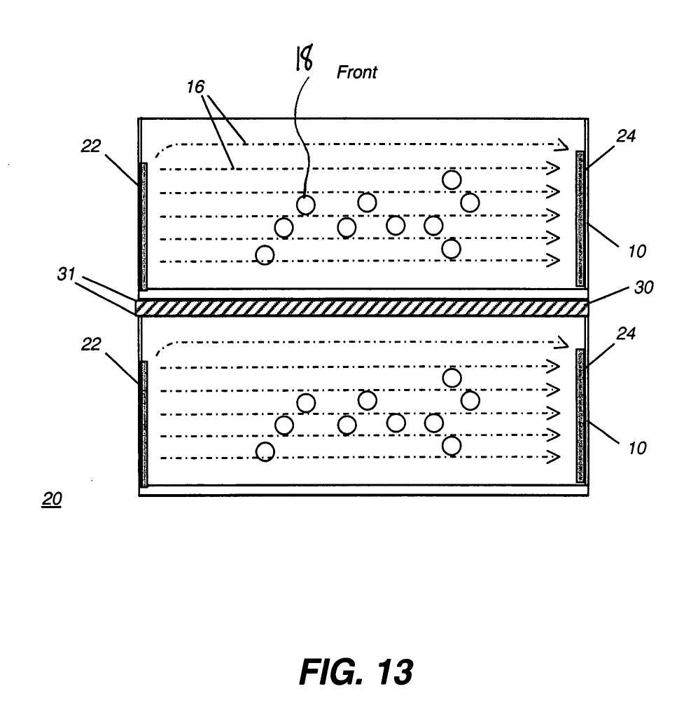

The cross-section view of FIG. 4 shows the general solution to this problem provided by the present invention. To minimize electrical field crosstalk, an electrical field isolation layer 30 is disposed between adjacent electrophoretic cells 10 in stack of electrophoretic cells 20. Electrical field isolation layer 30 can take any of a number of forms, using various types of materials to isolate each electrophoretic cell 10 from its neighbor in a stack of electrophoretic cells 20, as described subsequently. At the same time, electrical field isolation layer 30 is substantially transparent to light path L. In each of the embodiments described subsequently, electrical field isolation layer 30 is a separate layer between electrophoretic cells 10; each electrophoretic cell 10 is bounded by at least a thin layer of a dielectric material. Thus, Electrical field isolation layer is not conductively coupled to electrophoretic cell 10 or its electrodes 22, 24. The electrical field isolation layer may have an adjacent adhesive layer 31 on either side thereof. Electrical field isolation layer 30 can take any of a number of forms, as described subsequently. FIG. 13 is a variation of FIG. 4 in which electrodes 22, 24 are on the side walls of the microcells.

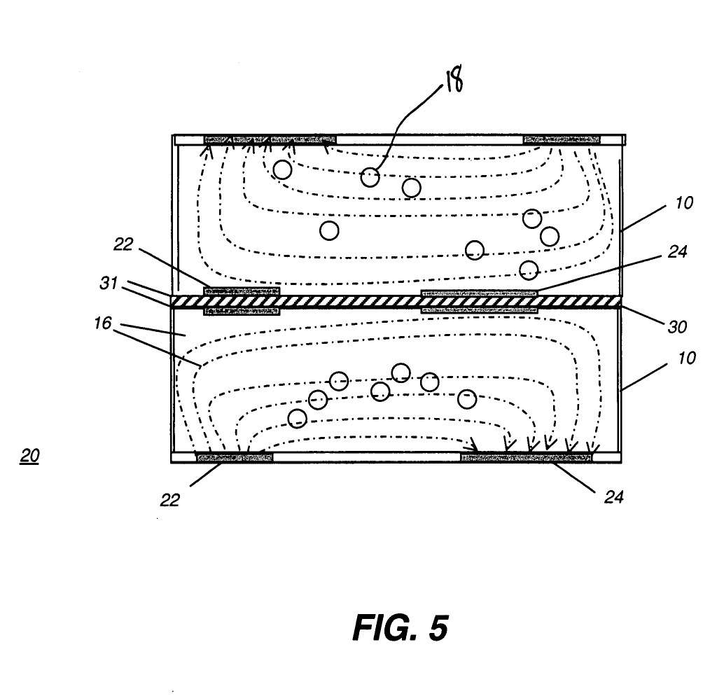

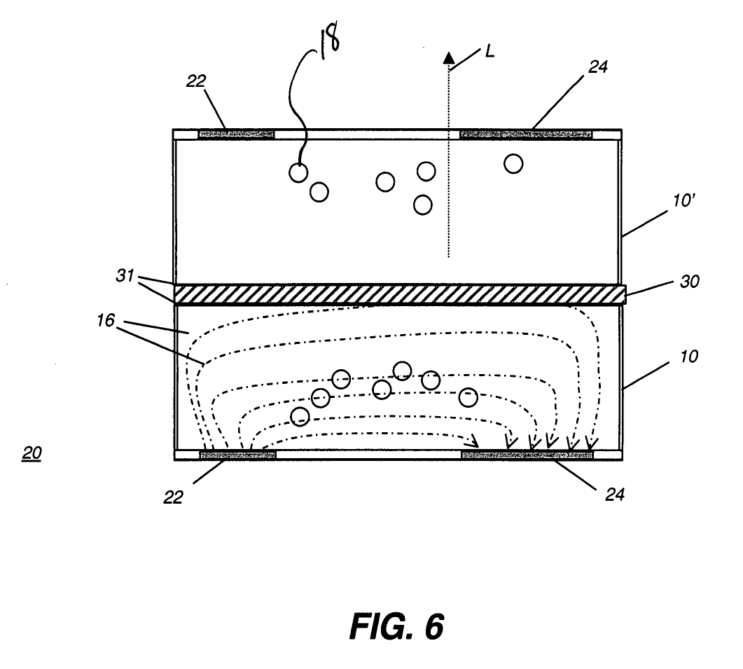

The cross-section views of FIGS. 4, 5, 6, 7, 8, and 13 show various arrangements of stacks of electrophoretic cells 20 having two or more component electrophoretic cells 10. The embodiment of FIG. 5 employs two sets of electrodes 22, 24 within each electrophoretic cell 10, disposed opposite each other, as in the arrangement described in U.S. Publication No. 2003/0231162 (Kishi) that is cited earlier in the background section. The opposed electrodes inherently provide an amount of shielding. A slight offset in the position of opposing electrodes can help to provide some measure of field isolation. In the embodiment of FIG. 6, the in-plane electrode 22, 24 orientation in an electrophoretic cell 10′ is vertically mirrored compared to its position in FIG. 4, so that the imaging material in each electrophoretic cell 10 and 10′ lies between the electrodes 22 and 24 for the cells. This maximizes the separation distance between electrodes 22, 24 between neighboring cells 10 and 10′, reducing the potential strength of crosstalk fields. With the arrangement of FIG. 6, it may even be possible to eliminate electrical field isolation layer 30 altogether or to minimize its thickness or materials requirements so that sealing layers or other components between electrophoretic cells 10, 10′ in a stack of electrophoretic cells 20 can serve this purpose.

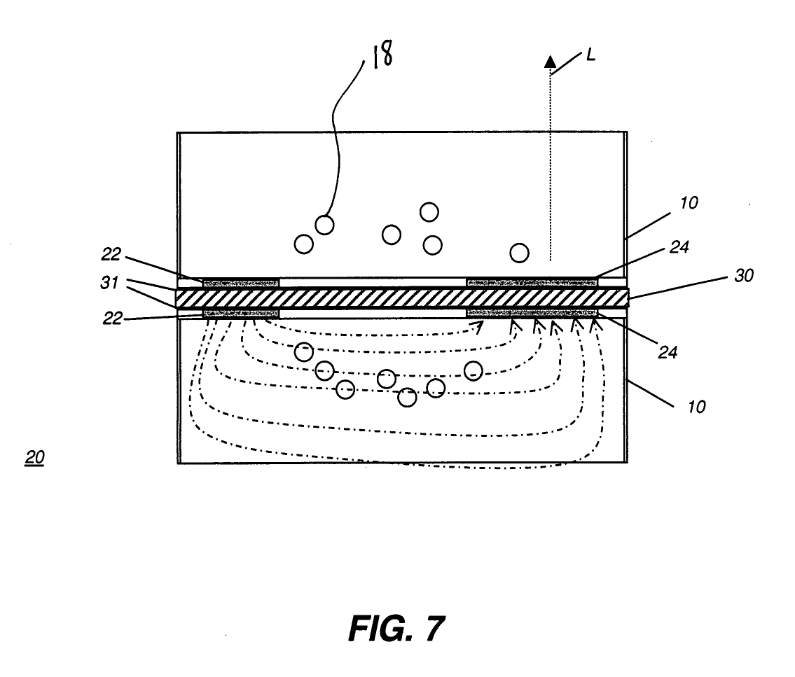

In the embodiment of FIG. 7, electrodes 22, 24 for neighboring electrophoretic cells 10 are disposed back-to-back. This arrangement may provide some inherent measure of field isolation; however, parasitic capacitance or other phenomena may make such an arrangement less desirable. The unit manufacturing cost is also likely to be higher than that for other embodiments shown here.

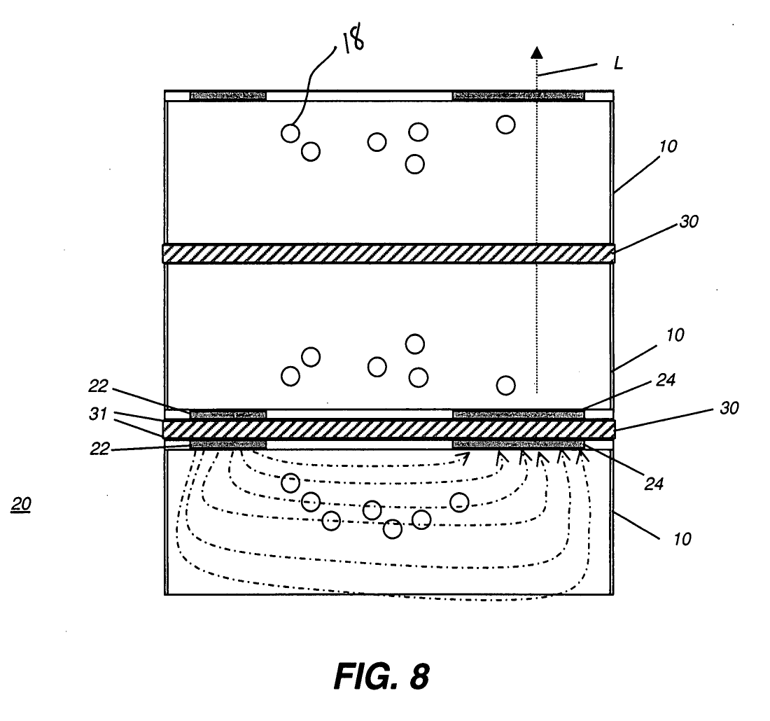

It should be observed that it is possible to provide a multicolor display using two electrophoretic cells 10 as shown in the embodiments of FIGS. 4 through 7. That is, one or the other of electrophoretic cells 10 in a stack of electrophoretic cells 20 may be able to provide more than one color, such as by controlling the positioning of two different color particles within the same cell, for example. This method is employed, for example, in the method described in U.S. Publication No. 2003/0231162 (Kishi) that is cited earlier in the background section. However, most conventional approaches to full-color display employ three color-forming elements, using either the primary colors (Red, Green, and Blue) or RGB or using complementary colors (Cyan, Magenta, Yellow) or CMY. FIG. 8 shows an embodiment in which a stack of electrophoretic cells 20 has three component electrophoretic cells 10. In one color display embodiment, imaging material in each of the three electrophoretic cells 10 would then provide a component primary color (Red, Green, or Blue) or a component complementary color (Cyan, Magenta, Yellow). Other colors could alternately be used, including black or white, for example.

Electrical field isolation layer 30 can work in a number of ways to deflect, weaken, shield, or otherwise diminish electrical field crosstalk between cells 10. In some embodiments, electrical field isolation layer 30 is passive, providing a type of fixed barrier or shield between cells to achieve the needed field isolation. Other embodiments use more dynamic mechanisms that adapt to a developed electrical field and dynamically counteract the field to reduce crosstalk. Subsequent embodiments describe various types of electrical field isolation layers 30 that could be used, singly or in combination, for a stack of electrophoretic cells 20 in a display apparatus.

In one type of passive embodiment, electrical field isolation layer 30 forms a conductive shield that effectively isolates one electrophoretic cell 10 from its neighbors in a stack of electrophoretic cells 20. This solution employs shielding effects that will be well understood from other contexts to those skilled in the electronic arts. For example, such shielding effects are widely used to isolate sensitive circuitry from externally generated electrical fields or other interference. For this solution, the field formed between electrodes 22 and 24 (as represented by field lines 16 in FIG. 4) impinges upon electrical field isolation layer 30 that is a conductive material. This causes a slight current to flow along electrical field isolation layer 30, effectively attenuating the field at and beyond the point of impingement.

For shield embodiments, electrical field isolation layer 30 must minimally have some non-zero electrical conductance and may be electrically coupled to a signal ground or other suitable ground or reference. In general, electrical field isolation layer 30 provides the best shielding isolation when it is continuous, fully spanning the two-dimensional area of electrophoretic cell 10 (that is, in the plane orthogonal to light path L). However, full coverage of this area may not be needed for sufficient electrical field isolation with stacked electrophoretic devices. In such a case, electrical field isolation layer 30 may be appropriately patterned.

When used for crosstalk shielding, electrical field isolation layer 30 is often grounded, but may be electrically “floating,” or may have some other suitable state, as determined in a particular application. Electrical field isolation layer 30 can also be switched, so that its potential changes over time. For example, electrical field isolation layer 30 can be switched to ground through a transistor or other solid state switching device. It should be noted that shield embodiments are similar to embodiments described subsequently that use low-resistivity c shielding methods and can impact device switching time due to parasitic capacitance. More detailed information on shielding resistivity and switching time is given subsequently in the discussion of low-resistivity materials.

One suitable material for electrical field isolation layer 30 is Indium Tin Oxide (ITO), familiar to those skilled in the electro-optical modulating electronic display device fabrication arts. ITO is reasonably elastic, is substantially transparent to visible light, and can be deposited and patterned suitably for forming a conductive shield layer. ITO is a cost effective conductor with good environmental stability, up to 90% transmission, and about 20 ohms per square resistivity. An exemplary preferred ITO layer has a % T greater than or equal to 80% in the visible region of light, that is, from greater than about 400 nm to 700 nm. In one embodiment, a conductive layer used as electrical field isolation layer 30 comprises a layer of low temperature polycrystalline ITO. The ITO layer is preferably between about 10-120 nm in thickness, or can be 50-100 nm thick to achieve a resistivity of 20-60 ohms/square on plastic. An exemplary preferred ITO layer is 60-80 nm thick.

Alternately, other metal oxides may be suitable, including titanium dioxide, cadmium oxide, gallium indium oxide, indium zinc oxide, niobium pentoxide and tin dioxide. See, Int. Publ. No. WO 99/36261 by Polaroid Corporation. In addition to the primary oxide such as ITO, a conductive layer used for shielding can also comprise a secondary metal oxide such as an oxide of cerium, titanium, zirconium, hafnium and/or tantalum. See, U.S. Pat. No. 5,667,853 to Fukuyoshi et al. (Toppan Printing Co.). Other transparent conductive oxides include, but are not limited to ZnO₂, Zn₂SnO₄, Cd₂SnO₄, Zn₂In₂O₅, MgIn₂O₄, Ga₂O₃ - - - In₂O₃, or TaO₃. A conductive layer may be formed, for example, by a low temperature sputtering technique or by a direct current sputtering technique, such as DC-sputtering or RF-DC sputtering, depending upon the material or materials of the underlying layer. Typically, the conductive layer is sputtered onto the substrate to a resistance of less than 250 ohms per square.

Conductive polymers offer a number of advantages, including transparency and ease of application onto a support surface. Conductive polymers selected from the group consisting of substituted or unsubstituted aniline containing polymers, substituted or unsubstituted pyrrole containing polymers, substituted or unsubstituted thiophene containing polymers may be suitable. These polymers provide the desired conductivity, adhesion, and light transmission needed for shielding in this application. Among the aforesaid electrically conductive polymers, those based on polypyrrole and polythiophene are particularly preferred as they provide optimum electrical and optical properties. Polythiophene based conductive polymers are particularly advantaged due to their commercial availability in large quantity.

Another suitable electrically conductive material for use in the present invention can be coated from a coating composition comprising a polythiophene/polyanion composition containing an electrically conductive polythiophene with conjugated polymer backbone component and a polymeric polyanion component. A preferred polythiophene component for use in accordance with the present invention contains thiophene nuclei substituted with at least one alkoxy group, e.g., a C₁-C₁₂ alkoxy group or a —O(CH₂CH₂O)ₙCH₃ group, with n being 1 to 4, or where the thiophene nucleus is ring closed over two oxygen atoms with an alkylene group including such group in substituted form. Preferred polythiophenes for use in accordance with the present invention may be made up of structural units corresponding to the following general formula (I) 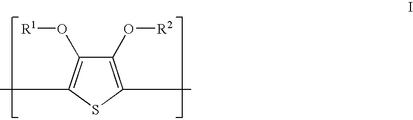
in which: each of R₁ and R² independently represents hydrogen or a C₁₋₄ alkyl group or together represent an optionally substituted C₁₋₄ alkylene group, preferably an ethylene group, an optionally alkyl-substituted methylene group, an optionally C₁₋₁₂ alkyl- or phenyl-substituted 1,2-ethylene group, 1,3-propylene group or 1,2-cyclohexylene group. The preparation of electrically conductive polythiophene/polyanion compositions and of aqueous dispersions of polythiophenes synthesized in the presence of polyanions, as well as the production of antistatic coatings from such dispersions is described in EP 0 440 957 (and corresponding U.S. Pat. No. 5,300,575), as well as, for example, in U.S. Pat. Nos. 5,312,681; 5,354,613; 5,370,981; 5,372,924; 5,391,472; 5,403,467; 5,443,944; and 5,575,898, the disclosures of which are incorporated by reference herein.

Polyanions used in the synthesis of these electrically conducting polymers are the anions of polymeric carboxylic acids such as polyacrylic acids, polymethacrylic acids or polymaleic acids and polymeric sulfonic acids such as polystyrenesulfonic acids and polyvinylsulfonic acids, the polymeric sulfonic acids being those preferred for this invention. These polycarboxylic and polysulfonic acids may also be copolymers of vinylcarboxylic and vinylsulfonic acids with other polymerizable monomers such as the esters of acrylic acid and styrene.

Polythiophene/polyanion compositions that can be employed in the present invention are commercially available and/or known in the art. Preferred electrically-conductive polythiophene/polyanion polymer compositions for use in the present invention include 3,4-dialkoxy substituted polythiophene/poly(styrene sulfonate), with the most preferred electrically-conductive polythiophene/polyanion polymer composition being poly(3,4-ethylene dioxythiophene)/poly(styrene sulfonate), which is available commercially from Bayer Corporation as Baytron P.

Other suitable electrically conductive polymers include, for example, poly(pyrrole styrene sulfonate) and poly(3,4-ethylene dioxypyrrole styrene sulfonate) as disclosed in U.S. Pat. Nos. 5,674,654 and 5,665,498, respectively.

Any polymeric film-forming binder, including water soluble polymers, synthetic latex polymers such as acrylics, styrenes, acrylonitriles, vinyl halides, butadienes, and others, or water dispersible condensation polymers such as polyurethanes, polyesters, polyester ionomers, polyamides, epoxides, and the like, may be optionally employed in the conductive layer to improve integrity of the conductive layer and to improve adhesion of the low-resistivity layer to an underlying and/or overlying layer. Preferred binders include polyester ionomers, vinylidene chloride containing interpolymers and sulfonated polyurethanes as disclosed in U.S. Pat. No. 6,124,083 incorporated herein by reference. The electrically-conductive polythiophene/polyanion composition to added binder weight ratio can vary from 100:0 to 0.1:99.9, preferably from 1:1 to 1:20, and more preferably from 1:2 to 1:20. The dry coverage of the electrically conductive substituted or unsubstituted thiophene-containing polymer employed depends on the inherent conductivity of the electrically-conductive polymer and the electrically-conductive polymer to binder weight ratio. A preferred range of dry coverage for the electrically-conductive substituted or unsubstituted thiophene-containing polymer component of the polythiophene/polyanion compositions is from about 0.5 mg/m² to about 3.5 g/m², this dry coverage should provide the desired electrical resistivity values while minimizing the impact of the electrically-conductive polymer on the color and optical properties of the article of the invention.

In addition to the electrically-conductive agent(s) and polymeric binder, the electrically-conductive materials useful in the invention may include crosslinking agents, organic polar solvents such as N-methyl pyrrolidone, ethylene or diethylene glycol, and the like; coating aids and surfactants, dispersing aids, coalescing aids, biocides, matte particles, dyes, pigments, plasticizer, adhesion promoting agents, particularly those comprising silane and/or epoxy silane, waxes, and other lubricants. A common level of coating aid in the conductive coating formula, e.g., is 0.01 to 0.3 weight % active coating aid based on the total solution weight. These coating aids are typically either anionic or nonionic and can be chosen from many that are applied for aqueous coating. The various ingredients of the coating solution may benefit from pH adjustment prior to mixing, to insure compatibility. Commonly used agents for pH adjustment are ammonium hydroxide, sodium hydroxide, potassium hydroxide, tetraethyl amine, sulfuric acid, acetic acid, etc.

The electrically-conductive materials useful in the invention may be applied from either aqueous or organic solvent coating formulations using any of the known coating techniques such as roller coating, gravure coating, air knife coating, rod coating, extrusion coating, blade coating, curtain coating, slide coating, and the like. After coating, the layers are generally dried by simple evaporation, which can be accelerated by known techniques such as convection heating. Known coating and drying methods are described in further detail in Research Disclosure No. 308119, Published December 1989, pages 1007 to 1008.

As mentioned above, a conductive layer used for shielding may be continuous or patterned. Selective removal of material for patterning is achieved by any method known in the art such as laser ablation, chemical etching with the further application of a patterned photoresist or by the application of a patterned removable layer (material with little or no adhesion) to an underlying support prior to applying the conductive material. One method of forming a metal grid pattern is disclosed in commonly assigned GB Application No. 05185093, filed Sep. 13, 2005, hereby incorporated by reference. After the application of the conductive material, the patterned removable layer may be washed away, leaving the conductor only in those areas that did not contain the removal layer. Other patterning options include ink jet deposition, photolithography, or electroplating, depending upon the conductive material used. Direct patterning options include additive process inkjet, screen printing, gravure, and other printing methods. Pattern spacing, for example of grid lines, can be relevant for obtaining the most effective field shielding. Typically, for example, smaller spacing dimensions provide a more effective shielding effect than do larger spacing dimensions. Preferably, spacings less than 20 μm are desirable. A patterned conductive layer, however, may be advantageous in order to provide better optical properties with some conductive materials or in order to allow lower material costs.

In one embodiment, field isolation layer 30 is first fabricated as a separate layer then sandwiched between state-changing layers 28a, 28b when display 32 is assembled (FIG. 3). However, in other embodiments, electrical field isolation layer 30 is formed directly onto the protective outer coating of the electrophoretic cells 10 for one or both of state-changing layers 28a, 28b.

Electromagnetic shielding as provided by a conductive layer or patterned conductive layer can help to minimize electrical crosstalk between neighboring electrophoretic cells 10. It should be noted, however, that parasitic capacitance and other effects that result from shielding can have a detrimental effect on cell switching time, as is described in more detail subsequently. Also, electrical field isolation layers made from other than dielectric materials preferably are electrically isolated, for example by a dielectric material, from any electrodes. Especially in the case of conductive materials, electrical isolation will prevent undesirable current draw from the display driver.

Another alternative embodiment of the passive type employs electronically or ionically conductive materials (collectively referred to as “low-resistivity materials”) as part of electrical field isolation layer 30. A wide variety of electrically conductive materials can be incorporated into a low-resistivity layer to produce a range of conductivities.

Some but not all antistatic materials are effective for an electrical field isolation layer. Antistatic materials can be divided into two broad groups: (i) ionic conductors and (ii) electronic conductors. In ionic conductors, charge is transferred by the bulk diffusion of charged species through an electrolyte. Antistatic layers containing simple inorganic salts, alkali metal salts of surfactants, ionic conductive polymers, polymeric electrolytes containing alkali metal salts, and colloidal metal oxide sols (stabilized by metal salts), described previously in patent literature and well known to those skilled in antistatic methods, fall in this category. The conductivity of antistatic layers employing an electronic conductor depends on electronic mobility, rather than ionic mobility, and is independent of humidity. Antistatic layers which contain conjugated polymers, semiconductive metal halide salts, and semiconductive metal oxide particles, are well known.

In general, “anti-static” compositions are characterized by surface resistivities from about 10⁹ to about 10¹³ ohms/square. For embodiments of the present invention, however, a lower resistivity range is generally preferred, with surface resistivity generally between about 10⁻³ to about 10⁶ ohms/square. The lower end of this range includes materials that can be considered somewhat conductive. This range extends to include resistivity values typical of components used for Radio Frequency Interference (RFI) shielding and extends into the range of “static dissipative” materials, such as materials used for slowly draining static charge buildup from truck bed-liners, for example.

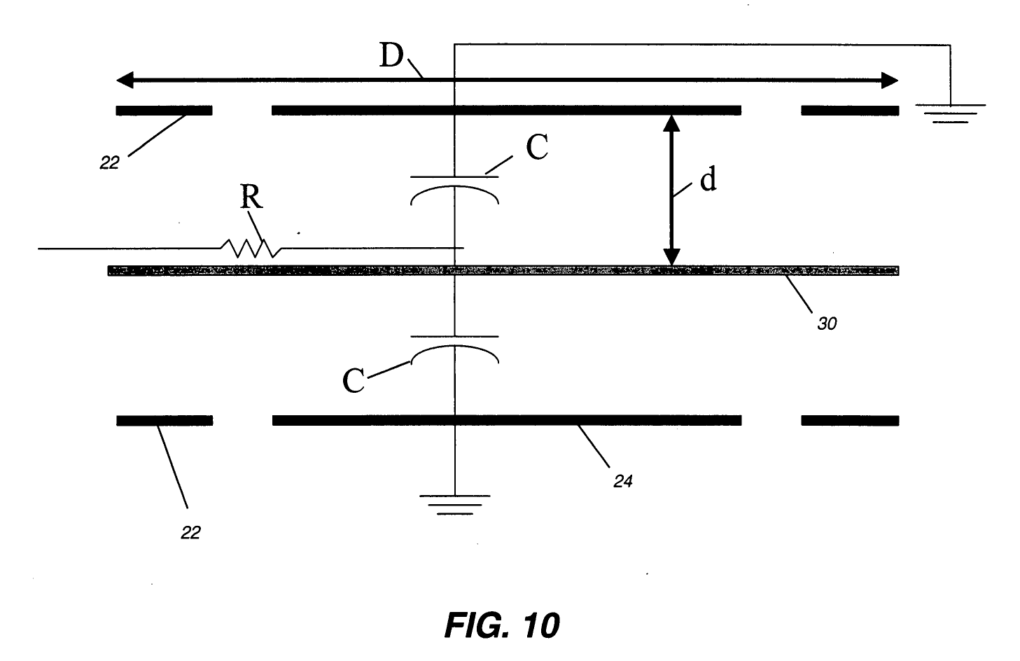

The allowable resistivity range for using a low-resistivity layer as electrical field isolation layer 30 is determined by factors including the maximum switching time for electrophoretic cell 10 and the relative amount of parasitic capacitance in the electrophoretic stack structure. This parasitic capacitance, combined with the inherent resistance provided by the low-resistivity layer, sets up an RC time constant that should be much lower than the switching time. Variables such as the distance between the low-resistivity layer and electrodes 22, 24 and the area extent of these electrodes, in turn, determine the inherent capacitive coupling that takes place. Referring to FIG. 10, there is given a simplified schematic diagram that shows key variables used to compute a suitable surface resistivity ρₛ for a given low-resistivity material. As a general computation for the RC time constant τ:

$$τ = ( \frac{R}{2} ) ( 2 C ) = {ρ}_{s} ( \frac{D}{W} ) ɛ ( \frac{WD}{d} ) = {ρ}_{s} ɛ ( \frac{{D}^{2}}{d} )$$

where R and C are the corresponding resistance and capacitance values, D and W are length and width of the electrode surface, thickness d is the vertical distance between electrical field isolation layer 30 and electrodes 22, 24, ρₛ is the surface resistivity of the low-resistivity material, and ε is the dielectric constant of the fluid between electrical field isolation layer 30 and electrodes 22, 24. Given that the following relationship is desired:
τ<<T_{switch}
where T_{switch} is the maximum switching time allowable, then the following condition should be met:

$${ρ}_{s} << ( \frac{d}{ɛ {D}^{2}} ) {T}_{switch}$$

Thus, for example, where the maximum switching time T_{switch} is relatively large such as 1 second, given typical values for dielectric constant ε and dimensions for display component thickness and extent as follows:
D=L=10 cm;
d=10 μm; and
ε=3(8.854×10⁻¹² F/m),
   then a surface resistivity value ρₛ of much less than about 3.8 (10⁷) ohms/square can be computed for a small display. A smaller switching time, such as would be more likely to be used for an electrophoretic device, would yield an even smaller surface resistivity value. For example, for switching time at nearer video rates, surface resistivity values of 10⁴ ohms/square or less would be needed for the same device architecture. Other changes could be made, such as increasing distance d to 20 micrometers, which would effectively reduce capacitive coupling and allow an increase in resistivity, providing for easier manufacture. However, this change would be at the cost of image quality, since thicker layers would be disadvantageous in this respect.

For field isolation, low-resistivity materials in the preferred range may take some time to respond. Low-resistivity antistatic materials can also be used in device fabrication, as disclosed in commonly assigned U.S. patent application Ser. No. 10/953,623 entitled, “Antistatic Layer for Electrically Modulated Display,” by Aylward et al.

Electrically conductive low-resistivity materials, such as conjugated conducting polymers, conducting carbon particles, crystalline semiconductor particles, amorphous semiconductive fibrils, and continuous or discontinuous conductive metal or semiconducting thin films may be used in this invention to provide shielding. Of the various types of electrically conductive low-resistivity materials, electronically conductive metal-containing particles, such as semiconducting metal oxides, and electronically conductive polymers, such as, substituted or unsubstituted polythiophenes, substituted or unsubstituted polypyrroles, and substituted or unsubstituted polyanilines can be particularly effective for the present invention.

Conductive metal-containing particles, which may be used in the present invention include conductive crystalline inorganic oxides, conductive metal antimonates, and conductive inorganic non-oxides. Crystalline inorganic oxides may be chosen from zinc oxide, titania, tin oxide, alumina, indium oxide, silica, magnesia, barium oxide, molybdenum oxide, tungsten oxide, and vanadium oxide or composite oxides thereof, as described in, for example, U.S. Pat. Nos. 4,275,103; 4,394,441; 4,416,963; 4,418,141; 4,431,764; 4,495,276; 4,571,361; 4,999,276; and 5,122,445, all incorporated herein by reference.

The conductive crystalline inorganic oxides may contain a “dopant” in the range from 0.01 to 30 mole percent. Preferred dopants may include aluminum or indium for zinc oxide, niobium or tantalum for titania, and antimony, niobium or halogens for tin oxide. Alternatively, the conductivity can be enhanced by formation of oxygen defects by methods well known in the art. The use of antimony-doped tin oxide particles, such as those having an X-ray crystallite size less than 100 Å and an average equivalent spherical diameter less than 15 nm but no less than the X-ray crystallite size as taught in U.S. Pat. No. 5,484,694 incorporated herein by reference, is also contemplated.

Particularly useful electronically conductive metal-containing low-resistivity particles, which may be used in a low-resistivity layer, include acicular-doped metal oxides, acicular metal oxide particles, and acicular metal oxides containing oxygen deficiencies. In this category, acicular-doped tin oxide particles, particularly acicular antimony-doped tin oxide particles or acicular niobium-doped titanium dioxide particles, are preferred because of their availability. The aforesaid acicular conductive particles preferably have a cross-sectional diameter less than or equal to 0.02 μm and an aspect ratio greater than or equal to 5:1. Some of these acicular conductive particles, useful for the present invention, are described in U.S. Pat. Nos. 5,719,016; 5,731,119; 5,939,243; and references therein, all incorporated herein by reference.

The volume fraction of the acicular electronically conductive metal oxide particles in the dried low-resistivity layer may vary from 1 to 70% and preferably from 5 to 50% for optimum physical properties. For non-acicular electronically conductive metal oxide particles, the volume fraction may vary from 15 to 90%, and preferably from 20 to 80% for optimum properties.

The invention is also applicable where the conductive low-resistivity material comprises a conductive “amorphous” gel such as vanadium oxide gel comprised of vanadium oxide ribbons or fibers. Such vanadium oxide gels may be prepared by any variety of methods, including but not specifically limited to melt quenching as described in U.S. Pat. No. 4,203,769, ion exchange as described in DE 4,125,758, or hydrolysis of a vanadium oxoalkoxide as claimed in WO 93/24584 all incorporated herein by reference. The vanadium oxide gel is preferably doped with silver to enhance conductivity. Other methods of preparing vanadium oxide gels, which are well known in the literature, include reaction of vanadium or vanadium pentoxide with hydrogen peroxide and hydrolysis of VO₂ OAc or vanadium oxychloride.

Conductive metal antimonates suitable for use in accordance with the invention include those as disclosed in, U.S. Pat. No. 5,368,995 incorporated herein by reference and U.S. Pat. No. 5,457,013 incorporated herein by reference, for example. Preferred conductive metal antimonates have a rutile or rutile-related crystallographic structures and may be represented as M⁺² Sb⁺⁵₂0₆ (where M⁺²=Zn⁺²,Ni⁺², Mg⁺²,Fe⁺², Cu⁺², Mn⁺², Co⁺²) or M⁺³ Sb⁺⁵ O₄ (where M⁺³=In⁺³, Al⁺³, Sc⁺³, Cr⁺³, Fe⁺³). Several colloidal conductive metal antimonate dispersions are commercially available from Nissan Chemical Company in the form of aqueous or organic dispersions. Alternatively, U.S. Pat. Nos. 4,169,104 and 4,110,247 incorporated herein by reference teach a method for preparing M⁺² Sb⁺⁵₂ O₆ by treating an aqueous solution of potassium antimonate with an aqueous solution of an appropriate metal salt (for example, chloride, nitrate, sulfate) to form a gelatinous precipitate of the corresponding insoluble hydrate which may be converted to a conductive metal antimonate by suitable treatment. If used, the volume fraction of the conductive metal antimonates in the dried low-resistivity layer can vary from 15 to 90%, preferably from 20 to 80% for optimum physical properties.

Conductive inorganic non-oxides suitable for use as conductive low-resistivity particles in the present invention include metal nitrides, metal borides and metal silicides, which may be acicular or non-acicular in shape. Examples of these inorganic non-oxides include titanium nitride, titanium boride, titanium carbide, niobium boride, tungsten carbide, lanthanum boride, zirconium boride, or molybdenum boride. Examples of conductive carbon particles include carbon black and carbon fibrils or nanotubes with single walled or multi-walled morphology. Example of such suitable conductive carbon particles can be found in U.S. Pat. No. 5,576,162 and references therein incorporated herein by reference.

Suitable electrically conductive low-resistivity polymers that are preferred for incorporation in an electrical field isolation layer 30 of the invention are specifically electronically conducting polymers, such as those illustrated in U.S. Pat. Nos. 6,025,119; 6,060,229; 6,077,655; 6,096,491; 6,124,083; 6,162,596; 6,187,522; and 6,190,846 incorporated herein by reference.

These electronically conductive polymers include substituted or unsubstituted aniline-containing polymers (as disclosed in U.S. Pat. Nos. 5,716,550; 5,093,439; and 4,070,189 incorporated herein by reference), substituted or unsubstituted thiophene-containing polymers (as disclosed in U.S. Pat. Nos. 5,300,575; 5,312,681; 5,354,613; 5,370,981; 5,372,924; 5,391,472; 5,403,467; 5,443,944; 5,575,898; 4,987,042; and 4,731,408 incorporated herein by reference), substituted or unsubstituted pyrrole-containing polymers (as disclosed in U.S. Pat. Nos. 5,665,498 and 5,674,654 incorporated herein by reference), and poly(isothianaphthene) or derivatives thereof. These conducting polymers may be soluble or dispersible in organic solvents or water or mixtures thereof. Preferred conducting polymers for the present invention include polypyrrole styrene sulfonate (referred to as polypyrrole/poly (styrene sulfonic acid) in U.S. Pat. No. 5,674,654 incorporated herein by reference), 3,4-dialkoxy substituted polypyrrole styrene sulfonate, and 3,4-dialkoxy substituted polythiophene styrene sulfonate because of their color. The most preferred substituted electronically conductive polymers include poly(3,4-ethylene dioxythiophene styrene sulfonate), such as BAYTRON P supplied by Bayer Corporation, for its apparent availability in relatively large quantity. The weight % of the conductive polymer in the dried low-resistivity layer may vary from 1 to 99% but preferably varies from 2 to 30% for optimum physical properties.

The low-resistivity material may also include a suitable polymeric carrier, also referred to herein as a binder, to achieve physical properties such as adhesion, abrasion resistance, backmark retention and others. The low-resistivity layer is applied to a transparent substrate to form electrical field isolation layer 30. Preferably, the substrate for the display is a flexible plastic substrate, which can be any flexible self-supporting plastic film that supports the thin conductive metallic film. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials. The substrate determines to a large extent the mechanical and thermal stability of the fully structured composite film.

Suitable materials for the flexible plastic substrate include thermoplastics of a relatively low glass transition temperature, for example up to 150° C., as well as materials of a higher glass transition temperature, for example, above 150° C. The choice of material for the flexible plastic substrate would depend on factors such as manufacturing process conditions, such as deposition temperature, and annealing temperature, as well as post-manufacturing conditions such as in a process line of a displays manufacturer. Certain of the plastic substrates discussed herein can withstand higher processing temperatures of up to at least about 200° C., some up to 3000-350° C., without damage.

Typically, the flexible transparent plastic substrate is polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, acetate, for example, cellulose acetate, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyimide (PI), Teflon poly(perfluoro-alkoxy) fluoropolymer (PFA), poly(ether ketone) (PEEK), poly(ether ketone) (PEK), poly(ethylene tetrafluoroethylene)fluoropolymer (PETFE), or poly(methyl methacrylate) and various acrylate/methacrylate copolymers (PMMA). Aliphatic polyolefins may include high density polyethylene (HDPE), low density polyethylene (LDPE), and polypropylene, including oriented polypropylene (OPP). Polyolefins and cyclic polyolefins may be included. A preferred flexible plastic substrate is a cyclic polyolefin or a polyester. Various cyclic polyolefins are suitable for a flexible plastic substrate. Examples include ARTON made by Japan Synthetic Rubber Co., Tokyo, Japan; ZEANOR T made by Zeon Chemicals L.P., Tokyo Japan; and TOPAS made by Celanese A. G., Kronberg Germany. Arton is a poly(bis(cyclopentadiene)) condensate that is a film of a polymer. A preferred polyester is an aromatic polyester such as Arylite. Although various examples of plastic substrates are set forth above, it should be appreciated that the substrate can also be formed from other transparent materials such as glass and quartz.

Suitable polyesters include those produced from aromatic, aliphatic or cycloaliphatic dicarboxylic acids of 4-20 carbon atoms and aliphatic or alicyclic glycols having from 2-24 carbon atoms. Examples of suitable dicarboxylic acids include terephthalic, isophthalic, phthalic, naphthalene dicarboxylic acid, succinic, glutaric, adipic, azelaic, sebacic, fumaric, maleic, itaconic, 1,4-cyclohexanedicarboxylic, sodiosulfoisophthalic and mixtures thereof. Examples of suitable glycols include ethylene glycol, propylene glycol, butanediol, pentanediol, hexanediol, 1,4-cyclohexanedimethanol, diethylene glycol, other polyethylene glycols and mixtures thereof. Such polyesters are well known in the art and may be produced by known techniques, for example, those described in U.S. Pat. Nos. 2,465,319 and 2,901,466. Preferred continuous matrix polyesters are those having repeat units from terephthalic acid or naphthalene dicarboxylic acid and at least one glycol selected from ethylene glycol, 1,4-butanediol and 1,4-cyclohexanedimethanol. Poly(ethylene terephthalate), which may be modified by small amounts of other monomers, is especially preferred. Other suitable polyesters include liquid crystal copolyesters formed by the inclusion of suitable amount of a co-acid component such as stilbene dicarboxylic acid. Examples of such liquid crystal copolyesters are those disclosed in U.S. Pat. No. Nos. 4,420,607; 4,459,402; and 4,468,510.

Useful polyamides include nylon 6, nylon 66, and mixtures thereof. Copolymers of polyamides are also suitable continuous phase polymers. An example of a useful polycarbonate is bisphenol-A polycarbonate. Cellulosic esters suitable for use as the continuous phase polymer of the composite sheets include cellulose nitrate, cellulose triacetate, cellulose diacetate, cellulose acetate propionate, cellulose acetate butyrate, and mixtures or copolymers thereof. Useful polyvinyl resins include polyvinyl chloride, poly(vinyl acetal), and mixtures thereof. Copolymers of vinyl resins may also be utilized.

The flexible plastic substrate can be reinforced with a hard coating. Typically, the hard coating is an acrylic coating. Such a hard coating typically has a thickness of from 1 to 15 microns, preferably from 2 to 4 microns and can be provided by free radical polymerization, initiated either thermally or by ultraviolet radiation, of an appropriate polymerizable material. Depending on the substrate, different hard coatings can be used. When the substrate is polyester or Arton, a particularly preferred hard coating is the coating known as “Lintec.” Lintec contains UV-cured polyester acrylate and colloidal silica. When deposited on Arton, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

The low-resistivity layer may be applied to the substrate or support in a manner capable of producing a layer or layers that allow an electrical charge to travel along the substrate until the charge can be grounded or the level of charge be dissipated so as to weaken any impinging electrical field and thereby minimize crosstalk.

The low-resistivity layer may be a coated or printed layer. The layer may be applied onto a substrate or support by conventional coating and printing means commonly used in this art. Coating methods may include, but are not limited to, extrusion coating, blade coating, wound wire rod coating, slot coating, hopper and slide hopper coating, gravure coating, curtain coating, spray coating, or inkjet coating. Printing methods may include gravure printing, offset printing, thermography, screen printing, electrophotography and other techniques. Some of these methods allow for simultaneous coatings of layers, which is preferred from a manufacturing economic perspective. Simultaneous coating may include simultaneous or consecutive extrusion coating or combinations thereof.

The surface on which the low-resistivity layer is deposited may be treated for improved adhesion by any of the means known in the art, such as acid etching, flame treatment, corona discharge treatment, glow discharge treatment or may be coated with a suitable primer layer. Corona discharge treatment is a preferred means for adhesion promotion. A low-resistivity layer may also be applied over an adhesion promoting primer layer of an interpolymer of a primary amine addition salt, as disclosed in U.S. Pat. No. 6,120,979.

Electrical field isolation layer 30 can also be a dynamic component that reacts to fields generated within neighboring electrophoretic cells 10. The term “dynamic” as compared to “passive” applies to electrical field isolation layers in which the number of charged entities or species bears a relatively closer relationship to the number of charged particles in the microcells, as compared, for example, to conductive materials in which the charged species (for example, electrons) is multiple orders higher.

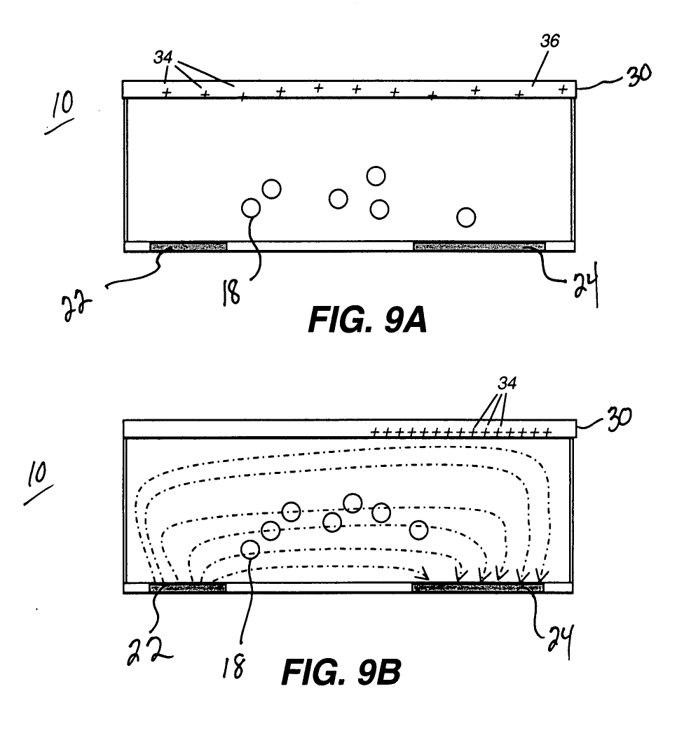

In one embodiment, electromagnetic shielding is provided using an adaptive conductive shield formed from portable charged species that are suspended in a fluid carrier within electrical field isolation layer 30. Referring to FIGS. 9A and 9B, the behavior of charged colloidal particles 34 in this dynamic embodiment is shown. In FIG. 9A, no electrical charge is applied. Charged colloidal particles 34 in electrical field isolation layer 30 are freely distributed throughout a surrounding dielectric fluid carrier 36. When a voltage is applied across electrodes 22, 24, an electric field is formed, causing alignment of charged colloidal particles 34 according to the charge polarity of electrodes 22, 24. The charged colloidal particles 34 are smaller and move more quickly than do charged particles 18 used for imaging. Thus, charged colloidal particles 34 quickly set up a counteracting field that tends to deflect the electrical field from electrophoretic cell 10, thereby minimizing crosstalk. Charged colloidal particles used for this embodiment must be substantially transparent or must at least be small enough to be effectively invisible.

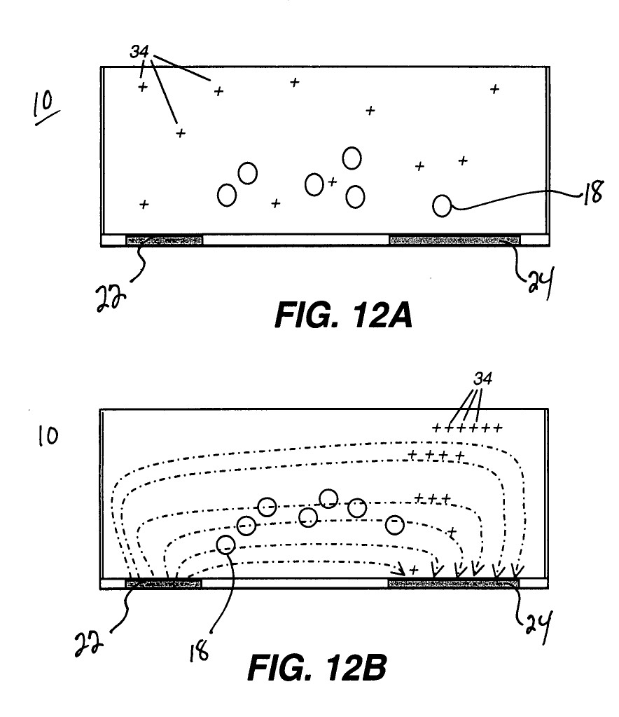

Another embodiment using charged colloidal particles in electrophoretic cell 10 itself is shown in FIGS. 12A and 12B. In FIG. 12A, with no electrical charge is applied, charged colloidal particles 34 are freely distributed within electrophoretic cell 10. When a voltage is applied across electrodes 22, 24, an electric field is formed as shown in FIG. 12B, causing alignment of charged colloidal particles 34 according to the charge polarity of electrodes 22, 24. The charged colloidal particles 34 are smaller and move more quickly than do charged particles 18 used for imaging. Thus, charged colloidal particles 34 quickly set up a counteracting field that tends to deflect the electrical field from electrophoretic cell 10, thereby minimizing crosstalk.

Micelles are one type of colloidal particle that has particular advantages for use in electrical field isolation layer 30 or in the dielectric fluid of electrophoretic cell 10 itself, as described with reference to FIGS. 12A and 12B. The micelle is an electrically charged colloidal particle or ion consisting of oriented molecules. A micelle can be formed from a dispersant to provide a colloidal aggregate of a unique number of amphipatic molecules (between 50 and 100), which occurs at a suitable temperature and at a concentration that is just above a well-defined critical micelle concentration. An amphipatic molecule is a molecule having both hydrophilic and hydrophobic groups, typically with a strongly polar head and a non-polar hydrocarbon chain that forms a long hydrophobic tail. In an aqueous or polar solvent, the inner core of the micelle consists of hydrophobic molecules, with hydrophilic molecules along the outer surface. In a non-polar solvent, hydrophilic groups move to the core and hydrophobic groups to the surface. Ionic micelles can have a significant amount of surface charge, making them ideal candidates for a dynamic embodiment of electrical field isolation layer 30.

Compounds for making micelles include dispersants comprising at least two different segments or moieties, where the first is relatively polar and the second relatively non-polar and soluble in a fluid carrier. For example, a first segment may comprise amine groups and a second segment may comprise repeat units of isobutylene or the like. Useful dispersants include poly(t-butylstyrene-co-lithium methacrylate) and those dispersants commercially sold under the trademarks OLOA and SOLSPERSE. SOLSPERSE 13940, for example, is a polyesteramine (aziridine-hydroxy stearic acid copolymer). A preferred dispersant is OLOA 11000, a polyethyleneimine substituted succinimide derivative of polyisobutylene.

Another class of micelle-forming dispersants useful for the practice of this invention are derived from small organic amine containing molecules, particularly, heterocyclic amines. Some preferred examples are, N-(1-acetyl-2,2,6,6-tetramethyl-4-piperidinyl)-2-dodecylsuccinimide (SANDUVOR 3058); 2-dodecyl-N-(2,2,6,6-tetramethyl-4-piperidinyl)-succinimide (SANDUVOR 3055); and 2-dodecyl-N-(1,2,2,6,6-pentamethyl-4-piperidinyl)-succinimide (SANDUVOR 3056). Generally, the dispersants are used in an amount that is from about 1 to 15 percent by weight of the total material in electrical field isolation layer 30. More preferably, the dispersant would be in the range of about 1 to 10 percent by weight.

Another embodiment of a dynamic electrical field isolation layer 30 employs a transparent hole transport layer or electron transport layer. These materials, while electrically isolated from the fluid and particulate components of electrophoretic cell 10, react quickly to the electrical field generated within cell 10 and operate by building up an effective charge that opposes the charge field. This response serves to effectively bend the electrical field away from the periphery of cell 10 and can provide a measure of isolation as a result.

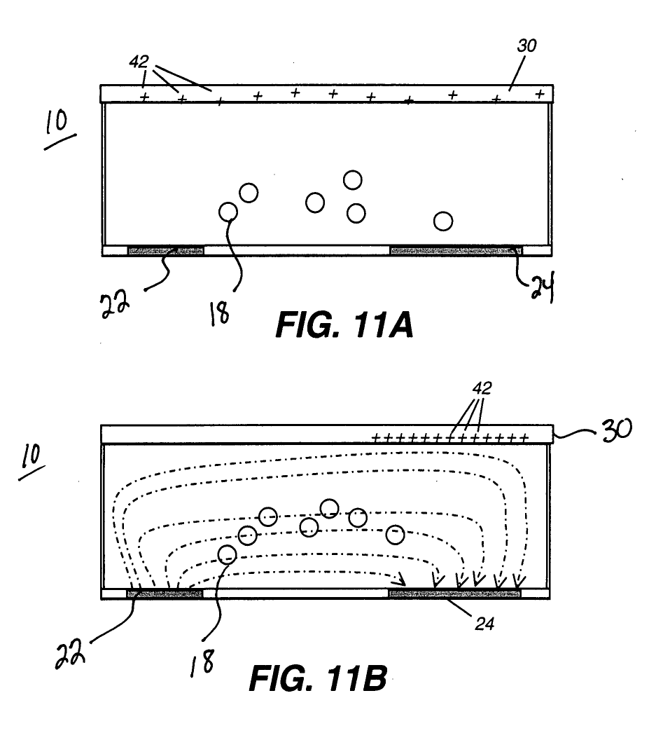

FIGS. 11A and 11B show the action of a hole transport layer when used as electrical field isolation layer 30. With no field applied, as in FIG. 11A, hole charge carriers 42 are distributed evenly throughout electrical field isolation layer 30. When a field is applied, as in FIG. 11B, hole charge carriers 42 align themselves spatially across from the oppositely charged electrode 24. In this way, hole charge carriers quickly set up a counteracting field that tends to deflect the electrical field within electrophoretic cell 10, thereby helping to minimize crosstalk. An electron transporting material would work similarly.

A hole-transporting layer contains at least one hole-transporting compound, such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals and/or comprising at least one active hydrogen containing group are disclosed by Brantley et al., U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. Such compounds include those represented by structural formula (A). 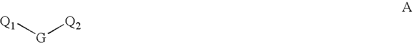
wherein Q₁ and Q₂ are independently selected aromatic tertiary amine moieties and G is a linking group such as an arylene, cycloalkylene, or alkylene group of a carbon to carbon bond. In one embodiment, at least one of Q₁ or Q₂ contains a polycyclic fused ring structure, e.g., a naphthalene. When G is an aryl group, it is conveniently a phenylene, biphenylene, or naphthalene moiety.

A useful class of triarylamines satisfying structural formula (A) and containing two triarylamine moieties is represented by structural formula (B): 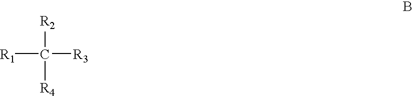
where

R₁ and R₂ each independently represents a hydrogen atom, an aryl group, or an alkyl group or R₁ and R₂ together represent the atoms completing a cycloalkyl group; and

R₃ and R₄ each independently represents an aryl group, which is in turn substituted with a diaryl substituted amino group, as indicated by structural formula (C): 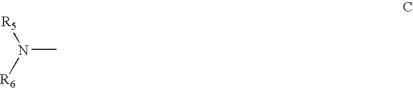
wherein R₅ and R₆ are independently selected aryl groups. In one embodiment, at least one of R₅ or R₆ contains a polycyclic fused ring structure, e.g., a naphthalene.

Another class of aromatic tertiary amines are the tetraaryldiamines. Desirable tetraaryldiamines include two diarylamino groups, such as indicated by formula (C), linked through an arylene group. Useful tetraaryldiamines include those represented by formula (D). 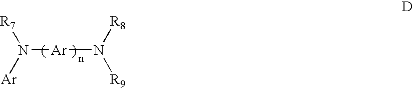
wherein
each Ar is an independently selected arylene group, such as a phenylene or anthracene moiety,
n is an integer of from 1 to 4, and
Ar, R₇, R₈, and R₉ are independently selected aryl groups.
In a typical embodiment, at least one of Ar, R₇, R₈, and R₉ is a polycyclic fused ring structure, e.g., a naphthalene

The various alkyl, alkylene, aryl, and arylene moieties of the foregoing structural formulae (A), (B), (C), (D), can each in turn be substituted. Typical substituents include alkyl groups, alkoxy groups, aryl groups, aryloxy groups, and halogen such as fluoride, chloride, and bromide. The various alkyl and alkylene moieties typically contain from about 1 to 6 carbon atoms. The cycloalkyl moieties can contain from 3 to about 10 carbon atoms, but typically contain five, six, or seven ring carbon atoms—e.g., cyclopentyl, cyclohexyl, and cycloheptyl ring structures. The aryl and arylene moieties are usually phenyl and phenylene moieties.

The hole-transporting layer can be formed of a single or a mixture of aromatic tertiary amine compounds. Specifically, one may employ a triarylamine, such as a triarylamine satisfying the formula (B), in combination with a tetraaryldiamine, such as indicated by formula (D). When a triarylamine is employed in combination with a tetraaryldiamine, the latter is positioned as a layer interposed between the triarylamine and the electron injecting and transporting layer. Illustrative of useful aromatic tertiary amines are the following:

1,1-Bis(4-di-p-tolylaminophenyl)cyclohexane (TAPC)

1,1-Bis(4-di-p-tolylaminophenyl)-4-phenylcyclohexane

4,4′-Bis(diphenylamino)quadriphenyl

Bis(4-dimethylamino-2-methylphenyl)-phenylmethane

N,N,N-Tri(p-tolyl)amine

4-(di-p-tolylamino)-4′-[4(di-p-tolylamino)-styryl] stilbene

N,N,N′,N′-Tetra-p-tolyl-4-4′-diaminobiphenyl

N,N,N′,N′-Tetraphenyl-4,4′-diaminobiphenyl

N,N,N′,N′-tetra-1-naphthyl-4,4′-diaminobiphenyl

N,N,N′,N′-tetra-2-naphthyl-4,4′-diaminobiphenyl

N-Phenylcarbazole

4,4′-Bis[N-(1-naphthyl)-N-phenylamino]biphenyl

4,4′-Bis[N-(1-naphthyl)-N-(2-naphthyl)amino]biphenyl

4,4″-Bis[N-(1-naphthyl)-N-phenylamino]p-terphenyl

4,4′-Bis[N-(2-naphthyl)-N-phenylamino]biphenyl

4,4′-Bis[N-(3-acenaphthenyl)-N-phenylamino]biphenyl

1,5-Bis[N-(1-naphthyl)-N-phenylamino]naphthalene

4,4′-Bis[N-(9-anthryl)-N-phenylamino]biphenyl

4,4″-Bis[N-(1-anthryl)-N-phenylamino]-p-terphenyl

4,4′-Bis[N-(2-phenanthryl)-N-phenylamino]biphenyl

4,4′-Bis[N-(8-fluoranthenyl)-N-phenylamino]biphenyl

4,4′-Bis[N-(2-pyrenyl)-N-phenylamino]biphenyl

4,4′-Bis[N-(2-naphthacenyl)-N-phenylamino]biphenyl

4,4′-Bis[N-(2-perylenyl)-N-phenylamino]biphenyl

4,4′-Bis[N-(1-coronenyl)-N-phenylamino]biphenyl

2,6-Bis(di-p-tolylamino)naphthalene

2,6-Bis[di-(1-naphthyl)amino]naphthalene

2,6-Bis[N-(1-naphthyl)-N-(2-naphthyl)amino]naphthalene

N,N,N′,N′-Tetra(2-naphthyl)-4,4″-diamino-p-terphenyl

4,4′-Bis {N-phenyl-N-[4-(1-naphthyl)-phenyl]amino}biphenyl

4,4′-Bis[N-phenyl-N-(2-pyrenyl)amino]biphenyl

2,6-Bis[N,N-di(2-naphthyl)amine]fluorene

1,5-Bis[N-(1-naphthyl)-N-phenylamino]naphthalene

4,4′,4″-tris[(3-methylphenyl)phenylamino]triphenylamine

Another class of useful hole-transporting materials includes polycyclic aromatic compounds as described in EP 1 009 041. Tertiary aromatic amines with more than two amine groups may be used including oligomeric materials. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

Alternately, a transparent electron-transporting layer could be used. Preferred thin film-forming materials for use in forming an electron-transporting layer are metal chelated oxinoid compounds, including chelates of oxine itself (also commonly referred to as 8-quinolinol or 8-hydroxyquinoline). Such compounds help to inject and transport electrons and exhibit both high levels of performance and are readily fabricated in the form of thin films.

Other electron-transporting materials include various butadiene derivatives as disclosed in U.S. Pat. No. 4,356,429 and various heterocyclic optical brighteners as described in U.S. Pat. No. 4,539,507. Selected benzazoles are also useful electron transporting materials. Triazines are also known to be useful as electron transporting materials.

Another passive embodiment of electric field isolation layer 30 employs a transparent dielectric layer having a dielectric constant of greater than 10, preferably less than 100, more preferably between 10 to 90. Dielectric materials are non-conductive and may exhibit characteristic dielectric constants according to the type of material. There is already some portion of a transparent dielectric material used to seal the individual electrophoretic cells 10. In this embodiment, a separate transparent dielectric layer, having sufficient dielectric strength, dielectric constant (or permittivity) and thickness for field attenuation, is sandwiched between first and second state changing layers 28a, 28b (FIG. 3).

The dielectric material used in electric field isolation layer 30 may include a UV curable, thermoplastic, screen printable material, such as Electrodag 25208 dielectric coating from Acheson Corporation. A dielectric material may form an adhesive layer. Certain thermoplastic polyesters, such as VITEL 1200 and 3200 resins from Bostik Corp., polyurethanes, such as MORTHANE CA-100 from Morton International, polyamides, such as UNIREZ 2215 from Union Camp Corp., polyvinyl butyral, such as BUTVAR B-76 from Monsanto, and poly(butyl methacrylate), such as ELVACITE 2044 from ICI Acrylics Inc. may serve as dielectric materials and provide a substantial bond between electrophoretic cells.

A dielectric adhesive layer may be coated from common organic solvents at a dry thickness of one to three microns. A dielectric adhesive layer may also be coated from an aqueous solution or dispersion. Polyvinyl alcohol, such as AIRVOL 425 or MM-51 from Air Products, poly(acrylic acid), and poly(methyl vinyl ether/maleic anhydride), such as GANTREZ AN-119 from GAF Corp. can be dissolved in water and subsequently coated and laminated to a support layer. Aqueous dispersions of certain polyamides, such as MICROMID 142LTL from Arizona Chemical, polyesters, such as AQ 29D from Eastman Chemical Products Inc., styrene/butadiene copolymers, such as TYLAC 68219-00 from Reichhold Chemicals, and acrylic/styrene copolymers such as RAYTECH 49 and RAYKOTE 234L from Specialty Polymers Inc. can also be utilized as a dielectric adhesive layer as previously described.

In a preferred embodiment, the electro-optical imaging fluid used for the imaging material in the array of microcell reservoirs can be bistable, so that it forms an image when addressed with an electric field and then retains its image after the electric field is removed. Particularly suitable electro-optical imaging fluids that exhibit “bistability” include many types of electrochemical materials, electrophoretic fluid materials, fluids containing Gyricon particles, electrochromic fluids, magnetic materials, or chiral nematic liquid crystals.

The electrically modulated fluid material may also be a printable ink having an arrangement of particles or microscopic containers or microcapsules. Each constituent microcapsule can itself contain an electrophoretic composition of a fluid, such as a dielectric or emulsion fluid, and a suspension of colored or charged particles or colloidal material. The diameter of such constituent microcapsules typically used for this purpose generally ranges from about 30 to about 300 microns. According to one practice, the charged particles in such constituent microcapsules visually contrast with the surrounding dielectric fluid. According to another example, the electrically modulated material may include rotatable balls that can rotate to expose a different colored surface area, and that can migrate between a forward viewing position and/or a rear nonviewing position. One example of this type of imaging mechanism is the Gyricon technology that had been developed at one time by Xerox Corporation, Stamford, Conn. In the Gyricon device, a material was comprised of twisting rotating elements contained in liquid filled spherical cavities and embedded in an elastomer medium. The rotating elements were made to exhibit changes in optical properties by the imposition of an external electric field. Upon application of an electric field of a given polarity, one segment of a rotating element would rotate toward an observer of the display. Application of an electric field of opposite polarity would cause each element to rotate and expose a different segment to the observer. The bistable Gyricon display would maintain a given configuration until an electric field was actively applied to the display assembly. Gyricon particles typically had a diameter of about 100 microns. Gyricon materials were disclosed in U.S. Pat. Nos. 6,147,791; 4,126,854; and 6,055,091; the contents of which are herein incorporated by reference.

According to one practice, the microcell reservoirs 16 of a display device may be filled with electrically charged white particles in a black or colored dye. Examples of electrically modulated materials and methods of fabricating assemblies capable of controlling or effecting the orientation of the ink suitable for use with the present invention are set forth in International Patent Application Publication Number WO 98/41899, International Patent Application Publication Number WO 98/19208, International Patent Application Publication Number WO 98/03896, and International Patent Application Publication Number WO 98/41898, the contents of which are herein incorporated by reference.

The electrically modulated electro-optical imaging fluid 20 may also include material disclosed in U.S. Pat. No. 6,025,896, the contents of which are incorporated herein by reference. This material comprises charged particles in a liquid dispersion medium encapsulated in a large number of microcapsules. The charged particles can have different types of color and charge polarity. For example white positively charged particles can be employed along with black negatively charged particles. The described microcapsules are disposed between a pair of electrodes, such that a desired image is formed and displayed by varying the dispersion state of the charged particles. The dispersion state of the charged particles can be modulated using a variably controlled electric field applied to the electrically modulated material. According to a preferred embodiment, the particle diameters of the microcapsules are between about 5 microns and about 200 microns, and the particle diameters of the charged particles are between about one-thousandth and one-fifth the size of the particle diameters of the microcapsules. The microcells switch rapidly between two optically distinct, stable states simply by alternating the sign of an applied electric field.

Those skilled in the art will recognize that a variety of light-modulating electro-optical imaging materials are available and may be used in microcells of the present invention. The light-modulating material employed in connection with the present invention, is preferably bistable, not requiring power to maintain display of indicia, at least for a suitable period of time. Such devices, since they do not require a continuous driving circuit to maintain an image, exhibit significantly reduced power consumption due to their non-volatile “memory” characteristic.

A light-modulating electro-optical imaging fluid may be formulated to have a single color, such as black, white, or clear. The particulate components may be fluorescent, iridescent, bioluminescent, incandescent, or may include a wavelength specific radiation absorbing or emitting material for visible, ultraviolet, infrared light. There may be multiple layers of light-modulating material. Different layers or regions of the electrically modulated material may have different properties or colors. Moreover, the characteristics of the various layers may be different from each other. For example, one layer can be used to view or display information in the visible light range, while a second layer responds to or emits ultraviolet light.

Particles may be suspended in any of a group of dielectric solvents exhibiting desirable density halogenated or unhalogenated hydrocarbons and their derivatives. An individual electrophoretic cell 10 may have more than one type of particle, such that it is capable of providing two different colors or some combination thereof.

Dimensional values given herein for width and depth of electrophoretic cells 10 are intended to be exemplary and not limiting. In practice, designs that use thin layers and, therefore, tight spacing of adjacent cells are advantaged for minimizing problems of parallax, chromatic aberration, and other undesirable optical effects. As another general consideration, the optical design of stacked cells is optimized when refractive indices of the respective layers and their composite materials are well matched.

The invention has been described with reference to a preferred embodiment. However, it will be appreciated that variations and modifications can be effected by a person of ordinary skill in the art without departing from the scope of the invention. As was emphasized earlier, the present invention can be used for a stacked electrophoretic display or a display device that employs other types of stacked electro-optic cells. Where there are more than two electro-optic cells in a stack, different types of electrical field isolation layer can be used in combination within the same stack.

### PARTS LIST

10, 10′, 10a, 10b electrophoretic cell
12, 14 electrode
16 field line
18 particle
20 stack of electrophoretic cells
22, 24 electrode
26 microcell
28a, 28b state-changing layer
30 electrical field isolation layer
31 adhesive layer
32 display device
34 colloidal particles
36 fluid carrier
38 electrode layer
39 substrate
40 electro-optic cell
42 hole charge carrier
C capacitor
D length
d thickness
L light path
R resistor
W width

1. A stacked electro-optical modulating display comprising at least two stacked state-changing layers, the stacked display comprising an array of pixels for displaying an image, each pixel associated with one or more microcells in each of the stacked state-changing layers, the stacked electro-optical modulating display comprising:
(a) a first state-changing layer comprising a first array of microcells, each microcell in the first array containing a first imaging material that responds to a first electrical field to switch the microcell between at least two optical states, a first and second optical state;
(b) first electrodes , for each microcell in the first array in the first state-changing layer, that provide the first electrical field associated with changing the optical state in each microcell in the first array, the first electrodes spaced apart in a direction that is parallel to the plane of the first state-changing layer;
(c) a second state-changing layer adjacent the first state-changing layer, the second state-changing layer comprising a second array of microcells in which the microcells in the second array are spatially registered in pixel formation with the microcells in the first array, each microcell in the second array containing a second imaging material that responds to a second electrical field to switch the microcell between the first and second optical states;
(d) second electrodes, for each microcell in the second array in the second state-changing layer, that provide the second electrical field associated with changing the optical state of the microcell in the second array, the second electrodes spaced apart in a direction that is parallel to the plane of the second state-changing layer; and
(e) between the first state-changing layer and the second state-changing layer, a first electrical field isolation layer between the first array of microcells and the second array of microcells, for reducing or eliminating crosstalk between the spatially registered microcells in vertically adjacent state-changing layers in the stacked display.

2. The display of claim 1 wherein the first electrodes are disposed on or in relative proximity to the side, parallel to the face of the display, of the first state-changing layer that is opposite the first electrical field isolation layer, and wherein the second electrodes are disposed on or in relative proximity to the side, parallel to the face of the display, of the second state-changing, layer that is opposite the first electrical field isolation layer.

3. The display of claim 1 wherein the first electrodes are disposed on or in relative proximity to the side, parallel to the face of the display, of the first state-changing layer that is nearest the first electrical field isolation layer and wherein the second electrodes are disposed on or in relative proximity to the side, parallel to the face of the display, of the second state-changing layer that is nearest the first electrical field isolation layer.

4. The display of claim 1 wherein the first electrodes are disposed on or in relative proximity to the side, parallel to the face of the display, of the first state-changing layer that is opposite the first electrical field isolation layer and wherein the second electrodes are disposed on or in relative proximity to the side, parallel to the face of the display, of the second state-changing layer that is nearest the first electrical field isolation layer.

5. The display of claim 1 further comprising:
(f) a third state-changing layer, comprising a third array of microcells, on the side of the second state-changing layer opposite the first state-changing layer, in which the microcells in the third array are spatially registered in pixel formation with the microcells in the second array and the first array, each microcell in the third array containing a third imaging material that responds to a third electrical field to switch the microcell between said first and second optical states; and
(g) third electrodes, for each microcell in the third array in the third state-changing layer, that provide the third electrical field associated with changing the optical state of the microcell in the third array, the third electrodes spaced apart in a direction that is parallel to the plane of the third state-changing layer.

6. The display of claim 5 further comprising a second electrical field isolation layer between the second state-changing layer and the third-changing layer for reducing or eliminating crosstalk between the spatially registered microcells in vertically adjacent state-changing layers in the stacked display.

7. The display of claim 6 wherein the second electrodes are disposed on or in relative proximity to the side of the second state-changing layer that is opposite the second electrical field isolation layer and wherein the third electrodes are disposed on or in relative proximity to the side of the third state-changing layer that is opposite the second electrical field isolation layer.

8. The display of claim 6 wherein the second electrodes are disposed on or in relative proximity to the side of the second state-changing layer that is nearest the second electrical field isolation layer and wherein the third electrodes are disposed on or in relative proximity to the side of the third state-changing layer that is nearest the second electrical field isolation layer.

9. The display of claim 1 wherein the first imaging material comprises charged particles suspended in a fluid carrier.

10. The display of claim 1 wherein the first imaging material is an electrochromic imaging material.

11. The display of claim 1 wherein the first imaging material responds to the first electrical field by rotating charged particles suspended in a fluid carrier.

12. The display of claim 1 wherein the first electrodes and second electrodes are in-plane electrodes.

13. The display of claim 12 wherein, in addition to the first electrodes, there are out-of plane electrodes for each microcell in the first array that provide an additional electric field that is capable of switching the microcell to a third optical state, and wherein, in addition to the second electrodes, there are out-of plane electrodes for each microcell in the second array that provide an additional electric field that is capable of switching the microcell to a third optical state.

14. The display of claim 1 wherein the first electrical field isolation layer is an electrically conductive material.

15. The display of claim 1 wherein the first electrical field isolation layer is a low-resistivity material having a surface resistivity of from about 10⁻³ to about 10⁶ ohms/square.

16. The display of claim 15 wherein the first electrical field isolation layer is an electronically conductive low-resistivity material.

17. The display of claim 16 wherein the electronically conductive low-resistivity material comprises a material selected from the group consisting of conjugated conducting polymers, conducting carbon particles, semi-conducting or conducting particles or fibrils, and combinations thereof.

18. The display of claim 17 wherein the electronically conductive low-resistivity material comprises a material selected from the group of substituted or unsubstituted polythiophenes, substituted or unsubstituted polypyrroles, and substituted or unsubstituted polyanilines.

19. The display of claim 1 wherein the first electrical field isolation layer comprises a hole transport material.

20. The display of claim 19 wherein the first electrical field isolation layer comprises one or more aromatic tertiary amines or one or more polycyclic aromatic compounds.

21. The display of claim 1 wherein the first electrical field isolation layer comprises an electron transport material.

22. The display of claim 1 wherein the first electrical field isolation layer comprises a dielectric material having a dielectric constant of between 10 and 100.

23. The display of claim 1 wherein the first electrical isolation layer is a transparent material that forms a continuous layer of material, without holes, between the first array of microcells and the second array of microcells.

24. The display of claim 1 wherein the first electrical isolation layer forms a patterned layer of material, with a plurality of holes, between the first array of microcells and the second array of microcells, wherein either the material itself and/or its pattern renders transparent the first electrical isolation layer.

25. The display of claim 14 wherein the electrically conductive material comprises material selected from metal oxides and conductive polymers.

26. The display of claim 25 wherein the electrically conductive material comprises a compound selected from the group consisting of indium tin oxide and polythiophene.

27. The display of claim 1 wherein the first electrical field isolation layer comprises charged mobile particles.

28. The display of claim 27 wherein the charged mobile particles are colloidal particles dispersed in a carrier fluid.

29. The display of claim 28 wherein the carrier fluid in the first electrical isolation layer comprises substantially the same liquid components as in the first imaging material and the second imaging material.

30. The display of claim 27 wherein the first electrical field isolation layer comprises charged species in a carrier fluid that are substantially non-visible, wherein the charged species moves in response to the first electrical field, the speed of which is substantially greater than the speed of the particles in the microcells in the first array of microcells, in response to the first electrical field.

31. The display of claim 30 wherein the charged species in the carrier fluid of the first electrical field isolation layer are less than 100 nanometers in average diameter.

32. The display of claim 31 wherein the charged species in the carrier fluid are micelles or inverse micelles.

33. The display of claim 32 wherein the micelles move at a rate greater than the switching time of the first or second imaging materials.

34. The display of claim 32 wherein the micelles are formed from a dispersant.

35. The display of claim 34 wherein the dispersant is an organic polymer having a non-polar and polar segments and functionalized with a charged group having the same charge as the particles in microcells of the first state changing layer.

36. The display of claim 1 wherein the first and the second imaging materials form different colors.

37. The display of claim 36 wherein the different colors are primary colors, red, green or blue, or complementary colors, cyan, magenta, or yellow.

38. The display of claim 1 wherein each microcell in each array is no longer than 1000 μm along any dimension thereof, each microcell comprising side walls extending vertically from a lower substrate and sealed at the top, each microcell containing an electro-optical imaging fluid that comprises charged particles dispersed in a carrier fluid.

39. The display of claim 1 wherein the microcells in the first array, in plan view, has a circular, rectangular, square, or hexagonal shape.

40. The display of claim 1 wherein at least one of the microcells in the first array, in plan view, has a rectangular shape with a side dimensional ratio in the range from 1:1 to 1:5.

41. The display of claim 1 wherein the first imaging material and the second imaging material comprise an electrowetting fluid.

42. The display of claim 1 wherein the first electrodes and the second electrodes each comprise at least two electrically isolated electrode elements for forming an electrical field.

43. The display of claim 1 wherein each microcell in each array contains an electro-optical imaging fluid that comprises charged particles dispersed in a carrier fluid.

44. The display of claim 43 wherein the movement of particles in the imaging fluid in the first array of microcells, under the first electrical field, and the movement of the particles in the imaging fluid in the second array of microcells, under the second electrical field, is substantially parallel to the face of the display.

45. The display of claim 1 wherein the first electrical field isolation layer is electrically isolated from any electrodes between the first state-changing layer and the second state-changing layer.

46. The display of claim 1 wherein the first electrical field isolation layer is electrically grounded.

47. The display of claim 1 wherein the first electrical field isolation layer has transmission over the visible spectrum exceeding 75%.

48. The display of claim 1 wherein the first electrodes are disposed along side walls of the microcells in the first array of microcells, and the second electrodes are disposed along side walls of the microcells in the second array of microcells.

49. The stacked display of claim 1 wherein at least the first imaging material comprises particles of a first and a second color.

50. A stacked electro-optical modulating display comprising at least two stacked state-changing layers, the stacked display comprising an array of pixels for displaying an image, each pixel associated with one or more microcells in each of the stacked state changing layers:
(a) a first state-changing layer comprising a first array of microcells, each microcell in the first array containing a first imaging material that responds to a first electrical field to switch the microcell between at least two optical states, a first and second optical state, the first imaging material comprising charged colored colloidal particles and charged substantially invisible colloidal particles, relatively smaller than the charged colored colloidal particles, both particles dispersed in a carrier fluid, which particles respond to the first electrical field, but which charged substantially invisible colloidal particles effectively constrain field strength to within the microcell; and
(b) a second state-changing layer comprising a second array of microcells, each microcell in the second array containing a second imaging material that responds to a second electrical field to switch the microcell between at least two optical states, a first and second optical state, the second imaging material comprising charged colored colloidal first particles, of a different color than the particles in the first imaging material, and charged substantially invisible colloidal particles, relatively smaller than the charged colored colloidal particles, both particles dispersed in a carrier fluid, which particles respond to the first electrical field, but which charged substantially invisible particles effectively constrain field strength to within the microcell.

51. The display of claim 50 wherein the charged substantially invisible colloidal particles in the microcells of the first state-changing layer and the second state-changing layer are micelles or inverse micelles.

52. A stacked electro-optical modulating display comprising at least two stacked state-changing layers, the stacked display comprising an array of pixels for displaying an image, each pixel associated with one or more microcells in each of the stacked state-changing layers:
(a) a first state-changing layer comprising a first array of microcells, each microcell in the first array containing a first imaging material that responds to a first electrical field to switch the microcell between at least two optical states, a first and second optical state;
(b) first electrodes, for each microcell in the first array in the first state-changing layer, that provide said first electrical field associated with changing the optical state in each microcell in the first array, the first electrodes spaced apart in a direction that is parallel to the plane of the first state-changing layer;
(c) a second state-changing layer adjacent the first state-changing layer, the second state-changing layer comprising a second array of microcells in which the microcells in the second array are spatially registered in pixel formation with the microcells in the first array, each microcell in the second array containing a second imaging material that responds to a second electrical field to switch the microcell between the first and second optical state; and
(d) second electrodes, for each microcell in the second array in the second state-changing layer, that provide said second electrical field associated with changing the optical state of the microcell in the second array, the second electrodes positioned spaced apart in a direction that is parallel to the plane of the second state-changing layer;
wherein the first and second imaging materials substantially lie between the first and second electrodes, thereby substantially maximizing the distance between the first and second electrodes.
